(19) United States
(12) Patent Application Publication
(10) Pub. No.: US 2013/0177934 A1
(43) Pub. Date: Jul. 11, 2013

(54) Aminated Mesoporous Silica Nanoparticles, Methods of Making Same, and Uses Thereof

(71) Applicant: CORNELL UNIVERSITY, Ithaca, NY (US)

(72) Inventors: Ulrich Wiesner, Ithaca, NY (US); Teeraporn Suteewong, New York, NY (US)

(73) Assignee: CORNELL UNIVERSITY, Ithada, NY (US)

(21) Appl. No.: 13/717,008

(22) Filed: Dec. 17, 2012

Related U.S. Application Data
(60) Provisional application No. 61/576,073, filed on Dec. 15, 2011.

(51) Int. Cl. C07F 7/02

(52) U.S. Cl. CPC C07F 7/025
USPC 435/29; 556/413

(57) ABSTRACT

A mesoporous silica particle having 10 mole % to 65 mole % amine groups present in the silica of the particle and on the silica surface of the particle. The particle has Pm 3̅n symmetry and a size of 25 nm to 500 nm. Methods of making such particles from the low temperature reaction of silane precursor and amino silane precursors is provided. The particle can be used in applications such as imaging, drug delivery, catalysis, and CO₂ sequestration.

### CROSS-REFERENCE TO RELATED APPLICATIONS

This application claims priority to U.S. provisional patent application No. 61/576,073, filed Dec. 15, 2011, the disclosure of which is incorporated herein by reference.

### STATEMENT REGARDING FEDERALLY SPONSORED RESEARCH

This invention was made with government support under grant no. DMR-0611430 and DMR-1120296 awarded by the National Science Foundation, grant no. DE-FG02-97ER62443 awarded by the Department of Energy, grant no. R21DE018335 awarded by the National Institute of Dental and Craniofacial Research, and Cooperative Agreement Number 2009-ST-108-LR0004 with the U.S. Department of Homeland Security. The Government has certain rights in the invention.

### FIELD OF THE INVENTION

The present invention relates to aminated mesoporous silica nanoparticles. More particularly the invention relates to such nanoparticles having a particular amine content and pore structure, methods of making such particles, and uses thereof.

### BACKGROUND OF THE INVENTION

Silica-based ordered mesoporous materials have the combined advantages of both silica and mesoporous materials. The versatility of silica chemistry allows for facile integration with other materials, including metal nanoparticles, fluorescent molecules, or rare-earth elements. Mesoporous materials provide large surface area, high pore volume, and uniform pore size distributions. Combining the aforementioned advantages in both bulk and nanosized materials offers characteristics that can be used in a range of applications. Soon after the discovery in the early 1990s, scientists focused on broadening the functionalities of mesoporous silica, such as incorporating or attaching organic molecules.

Significant research efforts in recent years have been devoted to the development of nanoparticles for applications in biomedical imaging, sensing, and drug delivery. Nanoparticle architecture and composition are key to the achievable property profiles. Silica is one of the most studied nanoparticle matrix materials due to low toxicity, versatile bulk and surface chemistry, and biocompatibility. Ordered mesoporous silica nanoparticles in particular have attracted considerable interest due to their ability to reversibly load other compounds. Such particles provide high surface area and large pore volume, also necessary in sorption and catalysis applications, while maintaining the intrinsic properties of silica.

One problem that has not been addressed via mesoporous silica nanoparticles composition is that of endosomal escape. In drug delivery, e.g. in therapeutic applications in oncology, it is often desired to unload drugs into the cytoplasm of cells. However, typical endosomal uptake mechanisms lead to drug delivery vehicles encapsulated into endosomes, which are in the cytoplasm but are surrounded by a membrane. Endosomal escape is then necessary for the delivery vehicle and its drugs to reach the cytoplasm. In the past it has been proposed for polymeric materials that endosomal escape mechanisms can be triggered by specific polymer compositions including high amounts of amines. Existing synthesis protocols leading to low amine containing (˜4%) Pm 3̅n mesoporous silica only yielded micron-sized particles which is considered too large for bio-related applications, particularly for cellular uptake known to be strongly size dependent.

### BRIEF SUMMARY OF THE INVENTION

The present invention provides aminated mesoporous silica particles (MSPs) having having 10 to 65 mole % amine groups throughout the silica, i.e., within the silica walls and on the silica surface of the particles. The particles have cubic Pm 3̅n symmetry. The mesoporous silica particles of the present invention are also referred to herein as nanoparticles (e.g., MSNs).

In an aspect, the present invention provides an aminated mesoporous silica particle comprising amine groups throughout the silica, i.e., within the silica walls and on the silica surface of the particles. The particle mesostructure has cubic Pm 3̅n symmetry. The particle can have a size of from 25 nm to 500 nm The particles can be described as “mesoscopically-ordered, locally amorphous.” In an embodiment, the mesoporous silica particles further comprise a pore expanding moiety derived from a pore expanding molecule as described herein.

For example, by providing pure silica (e.g., TEOS) as well as amino functionalized silica precursors (e.g., APTES) in a reaction feed simultaneously, co-condensation of both precursors during silica particle formation leads to the incorporation of organic functional amines (e.g., primary, secondary, tertiary amines) throughout the wall and the surface of the mesoporous structures/nanoparticles. This is in contrast to post-synthesis approaches to amine functionalization in which the amino-silane precursors are condensed on the surfaces of the silica only. Thus, in an embodiment, the particle has amine groups not only on the surface of the particle, but throughout the silica in the particle.

In an embodiment, the mesoporous silica particle further comprises a plurality of cationic surfactant molecules. In an embodiment, the mesoporous silica particle further comprises a plurality of organic materials (e.g., organic compounds and biological compounds). The mesoporous silica particles can be surface functionalized (e.g., electrostatically bonded or covalently bonded) with the organic materials.

In an aspect, the present invention provides methods of making the aminated mesoporous silica particles. The methods are based on low temperature (e.g., 15° C. to 25° C.) reaction of silane precursors, amino silane precursors and, optionally, pore expander molecules and/or organically modified silane precursors (e.g., dye containing silanes).

In an aspect, the present invention also provides uses of the aminated mesoporous silica nanoparticles. For example, the nanoparticles can be used in imaging methods, drug delivery methods, as catalysts, and in CO₂ sequestration methods.

### BRIEF DESCRIPTION OF THE FIGURES

FIG. 1. Representative TEM images of (a) NH₂-MSNs (mesoporous silica nanoparticles) at low magnification, (b) NH₂-MSNs at [100] projection, (c) NH₂-MSNs at [111] projection, (d) TRITC-labeled NH₂-MSNs (inset: high magnification image at [100] projection) (e) large-pore NH₂-MSNs and (f) TRITC-labeled large-pore NH₂-MSNs.

FIG. 2. Representative SAXS patterns of (a) acid-extracted and (b) calcined NH₂-MSNs and (c) acid-extracted TRITC-labeled NH₂-MSNs.

FIG. 3. Representative N₂ sorption isotherms (inset: Pore Size Distribution (PSD) from adsorption branches) of (a) template-removed NH₂-MSNs and (b) template-removed large-pore NH₂-MSNs. For each particle case, two data sets are shown corresponding to acid-extracted and calcined samples, respectively.

FIG. 4. Representative confocal microscopy images of (a) endocytosed PEGylated and TRITC-labeled NH₂-MSNs into COS-7 cells and (b) endocytosed PEGylated and TRITC-labeled large-pore NH₂-MSNs into epithelial cells. Particles appear in red. Far-red plasma membrane dye (Cell Mask Deep Red, Em/Ex 660/677 nm) was used to label the cell membrane (blue). Cell cross-section images along two orthogonal directions (red and green lines) are shown at the top and on the right of each image (see text) and corroborate the presence of particles inside the cells. Scale bars are 10 μm.

FIG. 5. Example of hydrodynamic particle sizes of acid-extracted MSNs in water.

FIG. 6. Representative SAXS patterns of (a) acid-extracted large-pored NH₂-MSNs and (b) acid-extracted TRITC-labeled large-pored NH₂-MSNs.

FIG. 7. Correlation between the cubic indices assignments and the observed peak positions of examples of NH₂-MSNs. Dotted lines indicate possible (hkl) combinations for cubic lattices. The linear fitting (equation shown above left) is obtained through least squares method.

FIG. 8. Representative FTIR spectra of (a) acid-extracted MSNs (no APTES), (b) acid-extracted NH₂-MSNs and (c) acid-extracted large-pored NH₂-MSNs.

FIG. 9. Representative TGA of (a) acid-extracted MSNs (no APTES), (b) acid-extracted NH₂-MSNs and (c) acid-extracted large-pored NH₂-MSNs.

FIG. 10. Representative TEM images of acid-extracted samples of (a) control and X—NH₂-MSNs made from (b) 10, (c) 19, (d) 29, (e) 39, (f) 49, (g) 54, (h) 64, and (i) 69 mol % APTES in the reaction feed. Insets zoom in on selected areas (rectangles) showing pore structures. All scale bars are 200 nm.

FIG. 11. Representative SAXS diffractograms of acid-extracted samples of (a) control and NH₂-MSNs made from (b) 10, (c) 19, (d) 29, (e) 39, (f) 49, (g) 54, and (h) 64 mol % APTES in the reaction feed. The tick marks represent the calculated peak positions expected for hexagonal (a-f) and Pm 3̅n cubic (g-h) symmetry lattices with the basis vector lengths (a, see Table 5 for definitions) shown next to the curves.

FIG. 12. Representative FT-IR spectra (transmission) of acid-extracted control sample and NH₂-MSNs obtained from different mol % APTES in the reaction feed (10-54).

FIG. 13. Representative FT-IR (transmission) peak intensity ratios of N—H bending (1560 cm⁻¹) to Si—O—Si stretching (1087 cm⁻¹) vibrations of acid extracted control samples and NH2-MSNs obtained from different mol % APTES (10-54) in the reaction feed.

FIG. 14. Representative TEM images of 54-NH₂-MSNs taken at different time points in the synthesis after removal of CTAB. All scale bars are 200 nm

FIG. 15. Particle size from TEM analysis of 54-NH₂-MSNs taken at different time points from 6 to 120 minutes after removal of CTAB. The error bars reflect the size distribution of particles formed at different time points. The number of particles measured was 10-20 particles for early stages (5-15 minutes) and 40-140 particles for later stage (longer than 20 minutes).

FIG. 16. Representative TEM images of 54-NH₂-MSNs after CTAB removal taken at the 8 (a-b), 9 (c-d), and 10 (e-f) minute reaction time points (inset in f zooms in on selected area (rectangle) showing spherelike micelle structure, a key parameter for cubic structure formation). Part b is a high magnification image of the particle in the lower left corner of (a). Arrows in (c), (e), and (f) indicate particles that upon further magnification show lattice fringes as in (b).

FIG. 17. A series of representative TEM images of a 54-NH₂-MSN particle after 24 hours of reaction time and removal of CTAB taken at different tilting angles in the electron microscope. Insets zoom in on selected areas (rectangles) showing pore structure. Hanning window-filtered fast Fourier transform images of the entire particle are shown (c, f) for images with tilt angles −12° and 12° (b, e), respectively, where representative spots corresponding to lattice planes are indexed. All scale bars are 200 nm.

FIG. 18. Representative SAXS diffractograms of 54-NH₂-MSNs after CTAB removal taken at different time points in the particle synthesis from two different synthesis batches (a,b). The tick marks represent the calculated peak positions expected for Pm 3̅n cubic symmetry lattices with the basis vector lengths of (a) 9.41 and 9.66 nm for 2 hour and 24 hour curves and (b) 9.07 nm, 8.74 nm, 8.74 nm, and 9.47 nm for 2 hour, 3 hour, 4 hour, and 24 hour curves, respectively.

FIG. 19. Representative TEM images after 24 hour reaction times of acid-extracted 54-NH₂-MSNs synthesized using (a) 103.5 mM and (b) 409 mM NH₄OH concentrations. All scale bars are 200 nm.

FIG. 20. Representative SAXS diffractograms of acid-extracted 54-NH₂-MSNs after 24 hours reaction time synthesized at (a) 103.5 mM and (b) 409 mM NH₄OH concentrations. The tick marks represent the calculated peak positions expected for cubic symmetry lattices with the basis vector lengths shown above each curve.

FIG. 21. Representative thermogravimetric weight loss curves of control MSNs before (red) and after (black) removal of surfactants.

FIG. 22. Representative thermogravimetric weight loss curves of control sample and X—NH₂-MSNs after surfactant removal, where X=10, 19, 29, 39, 49 and 54 mol % APTES in the reaction feed.

FIG. 23. Representative N₂ adsorption and desorption isotherms of control sample and X—NH₂-MSNs after surfactant removal, where X=10, 19, 29, 39, 49, 54 and 64 mol % APTES in the reaction feed.

FIG. 24. Representative TEM images of 19-NH₂-MSNs taken at (a) 5 and (b) 8 minutes after removal of CTAB. All scale bars are 100 nm.

FIG. 25. Representative SAXS spectra of 19-NH₂-MSNs taken at different time points in the synthesis after removal of CTAB.

FIG. 26. Representative SAXS patterns taken for MSNs made using 54% APTES after 24 hours of reaction time: d₁₀₀=9.97 nm. s²=2 or 10 peaks are not apparent; 2nd-order derivative shows a negative minimum at 0.195 Å⁻¹ near s²=10. Thus the pattern is consistent with cubic aspect 5.

FIG. 27. Representative SAXS patterns taken for MSNs made using 64% APTES after 24 hours of reaction time: d₁₀₀=10.8 nm. s²=10 peak is observable as a slight inflection; 2nd-order derivative shows negative minimum at q˜0.182 A⁻¹. near s²=10. Thus the pattern is consistent with cubic aspect 5.

### DETAILED DESCRIPTION OF THE INVENTION

The present invention provides aminated mesoporous silica particles (MSPs) having 10 to 65 mole % amine groups present throughout the silica, i.e., within the silica walls and on the silica surface of the particles. The particles have cubic Pm 3̅n symmetry. The present invention also provides a method of making such mesoporous silica particles. The methods are based on low temperature reaction of silane precursors. The mesoporous silica particles of the present invention are also referred to herein as nanoparticles (e.g., MSNs).

The aminated mesoporous silica particles can be used as cargo (drug) delivery vehicles, imaging probes, or theranostic materials. Size and stability of (MSPs) in physiological media as well as surface properties are important in the aforementioned applications. Furthermore, the pore structure and geometry of MSPs are also important considerations in the use of such particles. These features influence uptake and release rates of adsorbents as diffusion rates are geometry-dependent. Width of pore entrance and pore/cavity size limit the size of guest molecules to be carried. The chemical functional groups present at the particle surface also contribute to adsorption-desorption affinity between adsorbate and adsorbent. Selection of the appropriate features is important for success in an application of interest.

In an aspect, the present invention provides an aminated mesoporous silica particle comprising amine groups present throughout the silica, i.e., within the silica walls and on the silica surface of the particles. The particle mesostructure has cubic Pm 3̅n symmetry. The particles can be described as “mesoscopically-ordered, locally amorphous.”

The mesoporous silica particle can have a broad range of sizes. For example, the particle has a size of from 25 nm to 500 nm, including all values to the nm and ranges therebetween. The particle size is measured as the diameter of the cubic particle.

The mesoporous silica particle has a pore structure with cubic Pm 3̅n symmetry. The structure of the particle can be described as the packing of spherical cages (pores), which are 3-dimensionally connected with small windows, arranging to form the cubic-like particle with Pm 3̅n symmetry. The particle has amorphous walls.

By “mesoporous” it is meant the particles have pores with a diameter of 2 nm to 50 nm, including all values to the nm and ranges therebetween. The particles may have microporosity and mesoporosity.

The mesoporous silica particles have desirable amounts of surface area. The surface area of the particles can be determined using, for example, N₂ soprtion and BET measurements that are known in the art. For example, the surface area of the particles measured by BET is 450 to 990 m²/g. The N₂ soprtion and BET methods are known in the art.

In an embodiment, the mesoporous silica particles further comprise a pore expanding moiety derived from a pore expanding molecule as described herein. In this case, the particles have pores with a diameter of 2.7 nm to 5.3 nm (according to the BJH model), or 3.7 nm to 9.6 nm (calculated using a geometrical model), including all values to the 0.1 nm and ranges therebetween.

The mesoporous silica particle can have different shapes (i.e., morphology). For example, the structure of the particle is truncated octahedral or cube-like.

The mesoporous silica particle has amine groups present throughout the silica, i.e., within the silica walls and on the silica surface (e.g., silica wall surface) of the particles. The amine groups can be primary amine groups, secondary amine groups, tertiary amine groups, or a combination thereof. In an embodiment, the particle has primary amines and secondary amines, where the secondary amines are in a gamma position relative to primary amines.

For example, by providing pure silica (e.g., TEOS) as well as amino functionalized silica precursors (e.g., APTES) in a reaction feed simultaneously, co-condensation of both precursors during silica particle formation leads to the incorporation of organic functional amines (e.g., primary, secondary, tertiary amines) throughout the wall and the surface of the mesoporous structures/nanoparticles. This is in contrast to post-synthesis approaches to amine functionalization in which the amino-silane precursors are condensed on the surfaces of the silica only. Thus, in an embodiment, the particle has amine groups not only on the surface of the particle, but throughout the silica in the particle.

The amount of amine groups in the mesoporous silica nanoparticle can vary. For example, the amount of amine is 10 mole % to 65 mole %, including all integer mole % values to the mole % and ranges therebetween. By amine mole % it is meant the percentage of moles of amine nitrogen atoms relative to the total number of moles of silicon atoms present in the particle. The moles of amine nitrogen atoms and silicon atoms present in the particle can be determined using elemental anaylsis data for the particle.

In an embodiment, the amount of amine is 10 mole % to 60 mole %. In an embodiment, the amount of amine is from 20 mole % to 35 mole %. The amount of amine can be measured by methods known in the art. The amount of amine can be determined by elemental analysis, Si-nuclear magnetic resonance (NMR) spectroscopy, Fourier transform infrared spectroscopy (FTIR), inductively coupled plasma mass spectroscopy, or inductively coupled plasma atomic emission spectroscopy.

In an embodiment, the mesoporous silica particle further comprises a plurality of cationic surfactant molecules. The cationic surfactant molecules can have an alkyl chain of from 14 to 18 carbons, including all integer values of carbons and ranges therebetween. The length of the alkyl chain of the cationic surfactant can be selected to vary the size of the pore dimensions of the silica particle of the present invention. Examples of suitable cationic surfactants include tetradecyl-trimethyl-ammonium bromide (C₁₄TAB), hexadecyltrimethylammonium bromide (C₁₆; CTAB), octadecyltrimethylammonium bromide (C₁₈; OTAB), and combinations thereof.

In an embodiment, the mesoporous silica particle further comprises a plurality of organic materials. The organic materials can be in the bulk of the particle and/or on the surface of the particle (e.g., electrostatically (e.g., ionically) or covalently bonded to the mesoporous silica particle), or sequestered in the pores of the particle. For example, the organic materials can be introduced to the particle either (i) conjugating the organic material to a silane precursor (providing, e.g., a dye-silane conjugate), (ii) via a post-synthesis surface functionalization (e.g., PEG chains, drugs, or targeting moieties) or (iii) via post-synthesis loading into the pores. Post-synthesis loading into the pores is interesting in particular for drugs in which case they can be easily delivered and released from the particles by diffusion. In an embodiment, the organic material is located in the bulk of the particle and on the surface of the particle, the material is not limited to the surface of the particle.

The organic materials can be selected from organic compounds, biomaterials, and combinations thereof. The term “organic compounds” as used herein refers to functional and non-functional organic groups, drugs (small and large), imaging probes (i.e., organic dyes (e.g., tetramethyl rhodamine isothiocyanate (TRITC),)), metal chelators (e.g., compounds having functional groups that can chelate metal ions), contrast agents (e.g., containing radioisotopes such as ¹²⁴I and gadolinium), sensor molecules, inhibitors, targeting moieties (e.g., biotin, streptavidin, and cell targeting components such as targeted therapeutics (e.g., dasatinib)), poly(ethylene glycol) (PEG) groups (which can provide steric stabilitzation/better bio-compatibility), poly(ethylene imine) groups, polymers, and combinations thereof. Examples of functional organic groups include, for example, amines, esters, and thiols. Non-functional organic groups include, but are not limited to alkyl groups.

Examples of biomaterials are selected from siRNA, DNA, RNA, enzymes, cell targeting components (e.g., monoclonal antibodies, aptamers, folate, peptides (e.g., arginine-glycine-aspartic acid (RGD), and cyclic forms thereof), proteins (e.g., green fluorescent protein (GFP)), liposomes, and combinations thereof.

Imaging probes (e.g., organic dyes) are covalently bound to the silica matrix in order to prevent dye leaching. When a dye is used, the dye-silane conjugates can be added to the reaction feed first. This was done in order to assure that the dyes get incorporated into the silica particle bulk and surface. The dyes can be incorporated by “post-synthesis” functionalization of the particles with dyes. Without intending to be bound by any particular theory, it is considered that co-condensation of dyes, resulting in incorporation into the bulk and surface of the particle, leads to increased quantum efficiency/brighter fluorescence of the dyes, and that it leaves the particle/pore surfaces free for further functionalization with other materials in a post-synthesis step.

The mesoporous silica particles can be surface functionalized (e.g., electrostatically bonded or covalently bonded) with the organic materials. For example, the particle can be surface functionalized with polymers such as poly(ethylene glycol) and poly(ethylene imine) (which is positively charged and thus would be electrostatically bonded to a negatively charged silica surface). One or more of the particle surfaces (or portions thereof) can be functionalized. The surfaces can be exterior surfaces and/or interior surfaces. The functionalization can cover at least a portion of a surface or the entire surface. A single functionalization can exist on a surface or more than one functionalization can be present on a single surface. The same functionalization can exist on multiple surfaces.

The organic material can provide a functional group and/or functional moiety on the surface of the nanoparticle. In an embodiment, at least a portion of a first surface of the particle is functionalized with a first functional group and/or a first functional moiety. In another embodiment, the first surface of the particle is an exterior surface, an interior surface, or both an exterior surface and an interior surface. In another embodiment, the at least a portion of a second surface of the particle is functionalized with a second functional group and/or second functional moiety.

The amine can be reacted to form a functional group or functional moiety (e.g., a first and/or second functional group or moiety) (other than an amine group) on the nanoparticle. Such reactions are known in the art. These functional groups or functional moieties can be reacted with other groups or moieties. For example, amine groups on the particle can conjugate to N-hydroxysuccinimidyl ester-fuctionalized PEG chain leading to the formation of amide bonds and covalently attached PEG groups on the particle surface.

The nanoparticle can be surface functionalized with organic materials. In an embodiment, the nanoparticle is surface functionalized polymer groups (e.g., PEG and PEI), targeting moieties, antibodies, peptides, nucleic acids (e.g., DNA, RNA), imaging probes, proteins, liposomes, polymers, and combinations thereof.

The present invention provides compositions comprising a plurality of nanoparticles. In an embodiment, the present invention provides a composition comprising the mesoporous silica particles. For example, a composition comprises a plurality of nanoparticles and a solvent (e.g., an aqueous solvent such as phosphate buffered saline (PBS) buffer).

In an aspect, the present invention provides methods of making the mesoporous silica particles. The methods are based on low temperature (e.g., 15° C. to 25° C.) reaction of silane precursors, amino silane precursors and, optionally, pore expander molecules and/or organically modified silane precursors (e.g., dye containing silanes). In an embodiment, the mesoporous silica nanoparticles are made by a method of the present invention.

In an embodiment, the method for making a mesoporous silica particles comprising the steps of: a) forming a reaction mixture comprising one or more silane precursor, one or more amino silane precursor, optionally, one or more pore expander molecule and/or one or more organically modified silane precursors, one or more cationic surfactant, and an aqueous solvent, wherein the mole % of amine silane precursor is from 10 mole % to 64 mole %, the pH of the reaction mixture is adjusted, if necessary, 10 to 11; b) allowing the reaction to proceed at a temperature of 15° C. to 25° C. until the desired mesoporous silica particles are formed. The reaction mixture is formed at and the reaction allowed to proceed at, independently, a temperature of 15° C. to 25° C., including all integer ° C. values and ranges therebetween. The mixture of silanes can be referred to as reaction feed. The ratio of silanes can be referred to as a feed ratio.

In an embodiment, step b) comprises holding the reaction mixture at 15° C. to 25° C. for 5 minutes after addition of the silane precursor and amino silane precursor; after the 5 minute holding time water is added to ongoing reaction; and allowing the reaction to proceed for 20 to 24 hours to complete particle formation.

In an embodiment, the reaction mixture does not comprise any pore expander molecule and the amine silane precursor is present at from 54 mole % to 64 mole %, including all integer mole % values and ranges therebetween. In an embodiment, the reaction mixture comprises pore expander molecules and the amine silane precursor is present at from 10 mole % to 54 mole %, including all integer mole % values and ranges therebetween.

Without intending to be bound by any particular theory, it is considered that the amount of amine in the silica nanoparticle is about half of what is in the reaction feed. For example, if tetraethyl orthosilicate (TEOS) and 3-aminopropyl triethoxysilane (APTES) are in the reaction feed, cubic particle symmetry is observed at feed compositions of from 54 to 64 mole % APTES. In another example, if a pore expander molecule is used in the synthesis of mesoporous silica (e.g., 1,3,5-trimethylbenzene), cubic symmetry in the particles is observed at APTES amounts in the feed reaction solution as low as 24 mole % and up to 54 mole %.

The method can further comprise the steps of neutralizing the reaction mixture after particle formation and isolating the particles. After neutralizing the reaction mixture and isolating the particles, the method can further comprise the step of removing the cationic surfactant. These steps can be carried out by methods known in the art.

The mesoporous silica particles are formed using silica precursors. The silica precursors do not have significant solubility in water. Mixtures of silica precursors can be used. Examples of suitable silica precursors include tetraethyl orthosilicate (TEOS) and tetrapropyl orthosilicate (TPOS). In an embodiment, the silica precursor is tetraethyl orthosilicate (TEOS).

The mesoporous silica particles are formed using amino silica precursors. The amino silica precursors have one or more amine groups. Mixtures of amino silica precursors can be used. Examples of suitable amino silane precursors include 3-aminopropyl triethoxysilane (APTES), 3-aminopropyl trimethoxysilane (APTMS), and N-(2-amino ethyl)-3-aminopropyltrimethoxysilane. In an embodiment, the amino silica precursor has a primary amine and a secondary amine, where the secondary amine is in a gamma position relative to the primary amine. In certain embodiments, an organic material is conjugated to a suitable amino silane precursor.

The mesoporous silica particles can be formed using pore expander molecules. The pore expander molecules are typically hydrophobic molecules that can reside inside the hydrophobic core of surfactant micelles. Examples of suitable expander molecules include aromatics (e.g., 1,3,5-trimethyl benzene), paraffins, and alcohols. Pore size can be selected based on the selection of the appropriate pore expander molecule and amount of pore expander used in the reaction feed. Without intending to be bound by any particular theory, it is considered that over a certain range of pore expander amount, the pore size increases linearly with the amount of pore expander used in the feed. For example, the pore expander was 1,3,5-trimethyl benzene used at molarities of between 0.047 and 0.129, leading to pore expansion from between 4 nm to 5.2 nm pore diameter according to BJH analysis.

The reaction mixture is formed in an aqueous solvent. Water is the majority of the solvent. In an embodiment, water is the solvent. The reaction mixture, optionally, includes an organic additive. Mixtures of organic solvents can be used. An example of a suitable organic additive is ethyl acetate. The pore expander molecules can be organic additives. The organic additives are present in the reaction mixture at less than 10% by volume.

The reaction mixture, optionally, includes a base catalyst. Examples of suitable base catalysts include ammonium hydroxide, sodium hydroxide and triethanolamine. In an embodiment, the base catalyst is added such that the pH of the reaction mixture is from 10 toll.

In an embodiment, the reaction mixture is formed by adding the reagents and solvents in the following order: water, cationic surfactant (dissolved in water), organic solvent (e.g., ethyl acetate), base catalyst (e.g., ammonium hydroxide) if present, pore expander (e.g., 1,3,5-trimethyl benzene) if present, organic molecule silane conjugate (e.g., dye-silane conjugate) if present, followed by the mixture of silane precursor and amine silane precursor (e.g., TEOS and APTES).

The steps of the method described in the various embodiments and examples disclosed herein are sufficient to produce the mesoporous silica particles of the present invention. Thus, in an embodiment, the method consists essentially of a combination of the steps of the method disclosed herein. In another embodiment, the method consists of such steps.

In an aspect, the present invention also provides uses of the mesoporous silica nanoparticles. For example, a composition comprising the mesoporous silica particles is used in an imaging method.

In an embodiment, the imaging method using a composition comprising the mesoporous silica particles of the present invention comprises the steps of: a) contacting a cell with a composition comprising the mesoporous silica particles of the present invention such that the cell takes up at least a portion of the particles; and b) obtaining an image of the cell from a).

The image of the method can be obtained in a variety of ways. For example, the image can be obtained using confocal microscopy, fluorescence microscopy, two-photon excitation microscopy, positron emission tomography (PET), magnetic resonance imaging (MRI), computer tomography (CT), and combinations thereof. If mesoporous silica particles of the present invention are labeled with an organic dye, they allow optical imaging modalities to be used. If additional imaging moieties are added to the particles (e.g. radioisotopes), then dual modality particles would be generated, allowing combinations of imaging techniques to be applied, e.g. optical plus PET, optical plus MRI, optical plus CT, and combinations thereof.

The mesoporous silica particles can be used in a number of drug delivery applications. Without intending to be bound by any particular theory, it is considered that the benefits in drug delivery comprise loading of the pores with drugs, targeting of the particles to specific biological environments (e.g. tumors) using targeting moieties on the particle surface, and drug release. Because the pore morphology is three-dimensionally connected, this will allow generating different release kinetics relative to, e.g. particles with hexagonal morphology, where the channels are straight and only have at maximum two entry/exit points.

The mesoporous silica particles can also be used in sensing, diagnosis, imaging probe (MRI), treatment (drug delivery), and use of the particles as catalyst supports. The tunability of the pore walls via organic moieties in the synthesis, and the three-dimensional continuity of the pores described herein can provide significant advantages over existing materials. In an embodiment, nanoparticles comprising a drug are used in a drug delivery method. In such a method, nanoparticles comprising a drug (or a composition comprising such nanoparticles) are administered to an individual (e.g., a human or non-human animal). The administration can be carried out by methods known in the art.

Due to the amine content, CO₂ can be absorbed in the pores of the particle and on the surface of the particle. Accordingly, the particles can be used in CO₂ sequestration applications. For example, the particles can be used as substrates in such applications.

The following examples are presented to illustrate the present invention. They are not intended to limiting in any manner.

### EXAMPLE 1

This example shows mesoporous silica nanoparticles with cubic symmetry. In this example the room temperature synthesis of mesoporous silica nanoparticles possessing cubic Pm 3̅n symmetry with very high molar ratios (>50%) of 3-aminopropyl triethoxysilane is demonstrated. The synthesis is robust allowing, e.g. for co-condensation of organic dyes without loss of structure. By means of pore expander molecules, the pore size can be enlarged from 2.7 to 5 nm, while particle size decreases. Adding pore expander and co-condensing fluorescent dyes in the same synthesis reduces average particle size further down to 100 nm. After PEGylation, such fluorescent aminated mesoporous silica nanoparticles are spontaneously uptaken by cells as demonstrated by fluorescence microscopy.

This example shows the room temperature synthesis of discrete, faceted Pm 3̅n highly aminated mesoporous silica nanoparticles (NH₂-MSNs), from 54 mol % APTES. The synthesis protocol is quite robust allowing the co-condensation of other functional moieties in the same synthesis, e.g. organic dyes, without appreciable loss of structure control. Further demonstrated is that the addition of pore expander 1,3,5-trimethylbenzene (TMB) to the synthesis increases pore size from 2.7 to 5 nm while decreasing overall particle size. Rendering these highly aminated, pore-expanded particles fluorescent by co-condensing organic dyes into the particles reduces particle size even further, down to about 100 nm, the smallest average particle size observed in this study. Finally, using fluorescence microscopy shown are first results on the cellular uptake of such highly aminated MSNs after surface PEGylation.

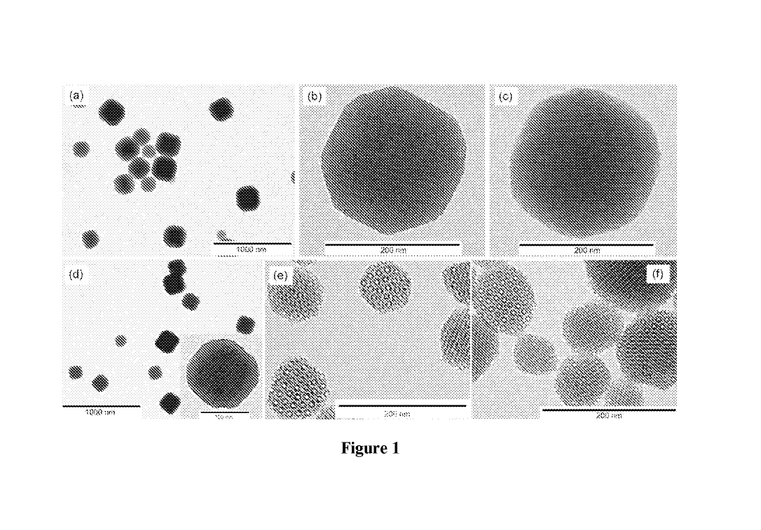

In general, NH₂-MSNs were prepared via base-catalyzed sol-gel silica reactions using hexadecyltrimethyl ammonium bromide (CTAB), TEOS, and high molar amounts of APTES in the presence of ethyl acetate. Reactions proceeded for 24 hours at room temperature. CTAB was removed by either acetic acid extraction or calcination. TEM images of acid-treated materials (FIG. 1a-c) reveal discrete and well-faceted mesoporous particles. The size of the smallest particles in FIG. 1a is down to about 100 nm, while the size of the largest particles is above 200 nm. For the larger particles, a truncated-octahedral shape can clearly be discerned from these images. Average particle size, as obtained from TEM image analysis, was about 220±50 nm, which is consistent with the hydrodynamic particle size of 220 nm determined from dynamic light scattering (DLS). Two projections of a truncated, octahedrally-shaped particle exhibiting four-fold and three-fold symmetries, i.e. along the [100] and [111] directions are shown in FIGS. 1b and c, respectively. Both these projections as well as the particle shape, suggest a cubic structure for these materials.

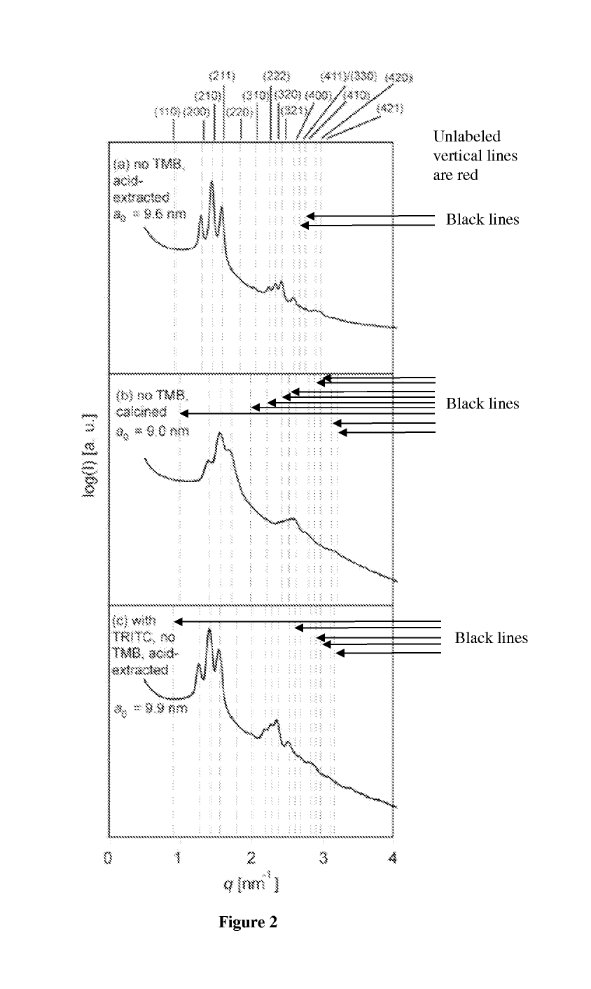

To further characterize the structure of the particles, small angle x-ray scattering (SAXS) was employed. SAXS patterns of dried powders of acid extracted and calcined materials are presented in FIGS. 2a and b, respectively. On first inspection, the SAXS pattern of the calcined sample is shifted to higher q values, where q denotes the scattering vector and is defined as q=4π sin θ/λ with a scattering angle of 2θ and the x-ray wavelength λ=1.54 Å. This shift likely results from a contraction of the siliceous matrix induced by further silica condensation upon calcination. Twelve peaks consistent with the (110), (200), (210), (211), (220), (310), (222), (320), (321), (400), (420) and (421) indices of a cubic lattice, can be observed in the pattern of the acid-extracted material (FIG. 2a). Allowed peaks corresponding to Pm 3̅n symmetry are indicated in FIG. 2 by vertical lines. Red lines are the observed peaks, while black lines indicate allowed positions missing in the scattering patterns. Albeit not as well resolved, at least five of the expected peaks for a Pm 3̅n lattice can be observed for the calcined material (FIG. 2b). The pattern in FIG. 2a was taken at the Cornell High Energy Synchrotron Source (CHESS), while the pattern of the calcined sample was taken at a rotating anode set up. The SAXS and TEM results combined are consistent with a cubic Pm 3̅n symmetry for the acid extracted sample, with unit cell dimensions (d₁₀₀)=9.6 nm. If one assumes that the calcined material has the same symmetry and the strongest peak is the (210) peak, then the unit cell dimension is 9.0 nm.

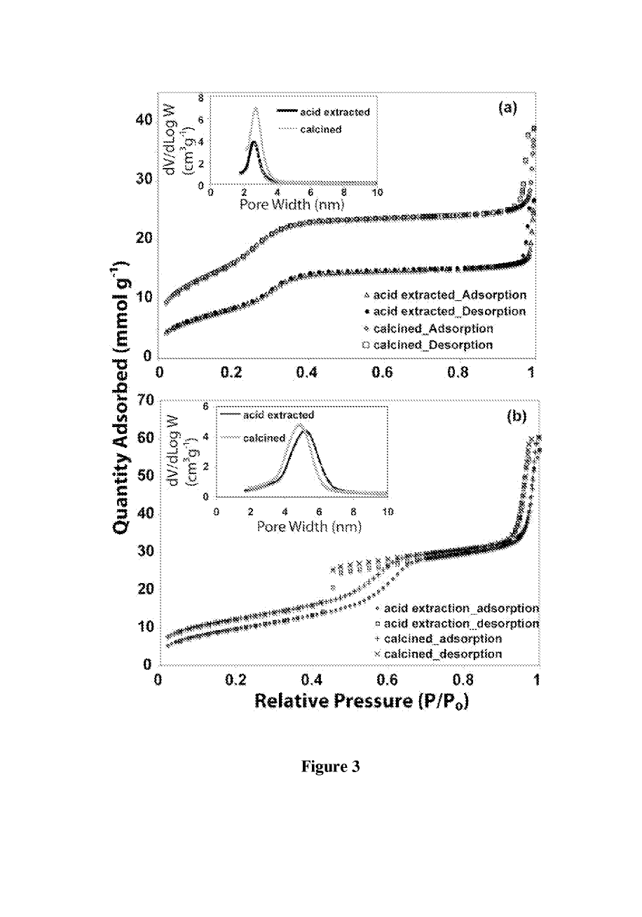

The amino groups are incorporated in the silica matrix without sacrificing pore size and morphology control. High amine content in these particles is reflected by a strongly positive zeta potential of the acid-extracted particles in water, i.e. 42±5 mV. In comparison, the reported zeta potential for non-aminated MCM-41-type MSNs is approximately −35 mV, i.e. highly negative as expected from the low isoelectric point (pH 2-3) of pure silica. N₂ sorption isotherms of acid-extracted and calcined mesoporous nanoparticles exhibit a type IV isotherm with small and narrow hysteresis loops at high relative pressure, which are due to incomplete desorption of N₂ from micropores (FIG. 3a). The BET surface area of the calcined sample is 1264 m²g⁻¹, and is almost two times higher than that of the acid-extracted sample, 674 m²g⁻¹. Thermogravimetric analysis suggested this to be the result of the degradation of the high amounts of organic moieties of APTES. In contrast, the pore sizes calculated using the BJH method of acid-extracted and calcined NH₂-MSNs (FIG. 3a, inset) are the same, i.e. 2.7 nm The BJH model assumes cylindrical pores and thus underestimates the true pore size. We thus also estimated the pore size as 3.7 (acid) and 3.4 (calcined) nm by a more appropriate geometrical model informed by previous studies.

In order to prepare NH₂-MSNs for fluorescence microscopy applications, we synthesized materials with TRITC dye covalently bound to the organically modified silica matrix. Inspection of these materials by TEM again reveals well-faceted nanoparticles and specific projections (FIG. 1d). SAXS scattering patterns of acid-extracted samples in dry form (FIG. 2c) were taken at CHESS. Twelve well-resolved peaks, consistent with the (200), (210), (211), (220), (310), (222), (320), (321), (400), (410), (420) and (421) indices of a cubic Pm 3̅n lattice with unit cell dimension (d₁₀₀)=9.9 nm can be observed for this fluorescent material (see below). Comparing FIGS. 1a and d with 2a and c, the combined TEM and SAXS results suggested that TRITC molecules covalently bound to the silica matrix did not significantly alter the formation of a cubic Pm 3̅n particle morphology. Average particle sizes as determined by TEM image analysis and DLS (about 215±45 and 190 nm, respectively) showed slightly smaller particles as compared to non-dye modified NH₂-MSNs, while zeta potentials stayed highly positive (see Table 1).

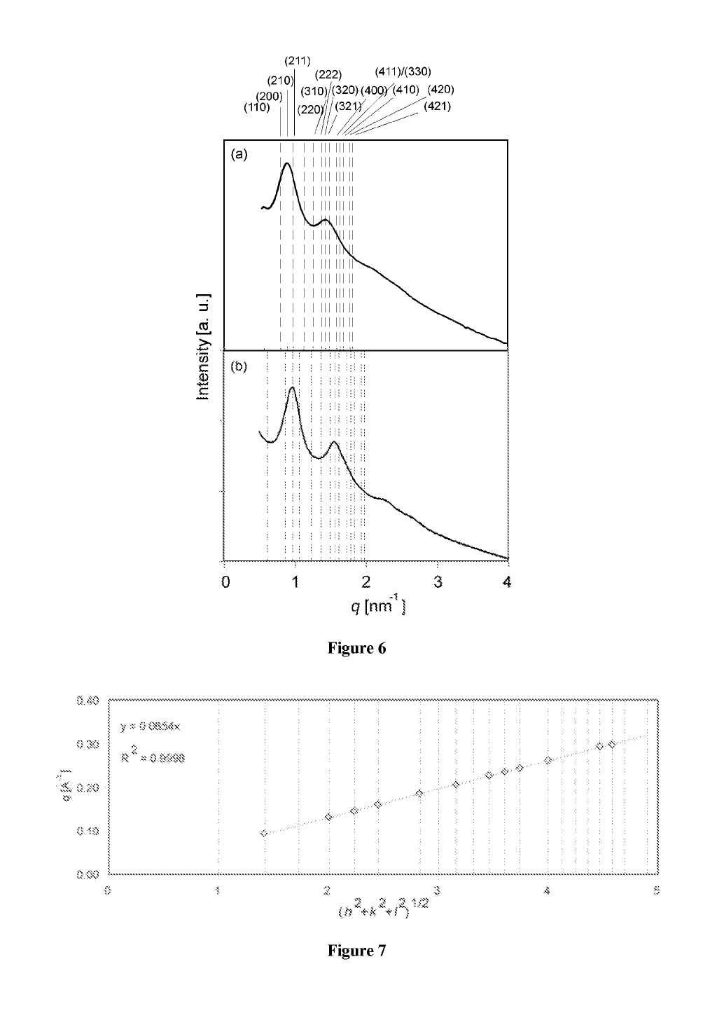

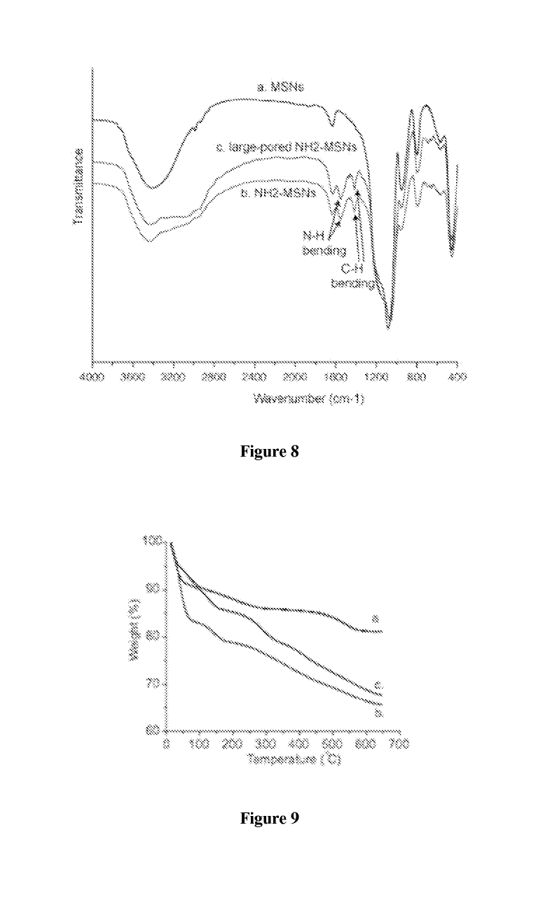

It is known that pore sizes in mesoporous silica can be tailored by pore expander molecules. To this end, we prepared large pore NH₂-MSNs with the aid of TMB. The TEM image in FIG. 1e suggests that a quasi-periodic structure is preserved under these conditions, but that the resulting particles are smaller than those synthesized in the absence of TMB (compare FIGS. 1e with 1b and c). Average particle sizes as observed from TEM image analysis and DLS are 110±25 and 164 nm, respectively, i.e. the TEM image analysis slightly underestimates sizes measured in solution. Repeated efforts to obtain SAXS diffractograms from acid-extracted large pore NH₂-MSNs only resulted in patterns (see FIG. 6a), in which the peaks are far less well resolved than those shown in FIG. 2a-c, for the particles synthesized in the absence of TMB. FIG. 6a also shows tic marks at the expected peak positions for a Pm 3̅n lattice, assuming that the first order maximum is the (210) reflection. The broad second peak in the pattern would then correspond to where the (222), (320) and (321) peaks would appear. If one assumes Pm 3̅n symmetry for the TMB acid-extracted material with strong peak at the (210) position then the unit cell size for this material is 16.4 nm, i.e. significantly larger than for materials synthesized without TMB, vide supra.

Zeta potential measurements on large pore NH₂-MSNs gave values comparable to those of materials synthesized in the absence of TMB (43±7 mV). The N₂ sorption isotherms (FIG. 3b) of acid-extracted and calcined large-pore aminated porous particles exhibit type IV isotherms with hysteresis loops. BET surface areas were determined as 780 m²g⁻¹ for acid-extracted samples and 990 M²g⁻¹ for calcined samples. The BJH (geometrical model) pore sizes were 5.3 (7.1) and 5 (6.6) nm for acid-extracted and calcined samples, respectively (FIG. 3b, inset), i.e. significantly larger than without TMB.

Elemental analysis confirmed amine contents as high as 20.45 and 23.38 mol % for aminated and large pore aminated MSNs, respectively. Differences relative to previously reported synthesis protocols that may allow this high amine loading are the use of ethyl acetate and slightly lower pH (pH in reaction is ˜11).

Intensive research efforts have recently been devoted to the exploration of interactions between silica nanoparticles and cells. To this end, herein, reported is the study of endocytosis-mediated internalization of nanoparticles into COS-7 and epithelial cells (SLC-44) using PEGylated and TRITC-labeled NH₂-MSNs and large-pore NH₂-MSNs as imaging probes, respectively. TEM images of TRITC-labeled large-pore NH₂-MSNs (FIG. 1f) suggest that the combination of covalent incorporation of TRITC molecules into the aminated silica and use of the pore expander TMB did not significantly disturb the formation of a cubic particle structure. Interestingly, the average particle size as determined by TEM and DLS (see Table 1) went down to about 100 nm suggesting that the use of dye and pore expander together leads to the smallest sizes observed in this study. This is consistent with a particle size reduction for both of these synthesis variations separately (see Table 1). A SAXS pattern for this material is depicted in FIG. 6b and shows similar features as the diffractogram of large-pore NH₂-MSNs in FIG. 6a.

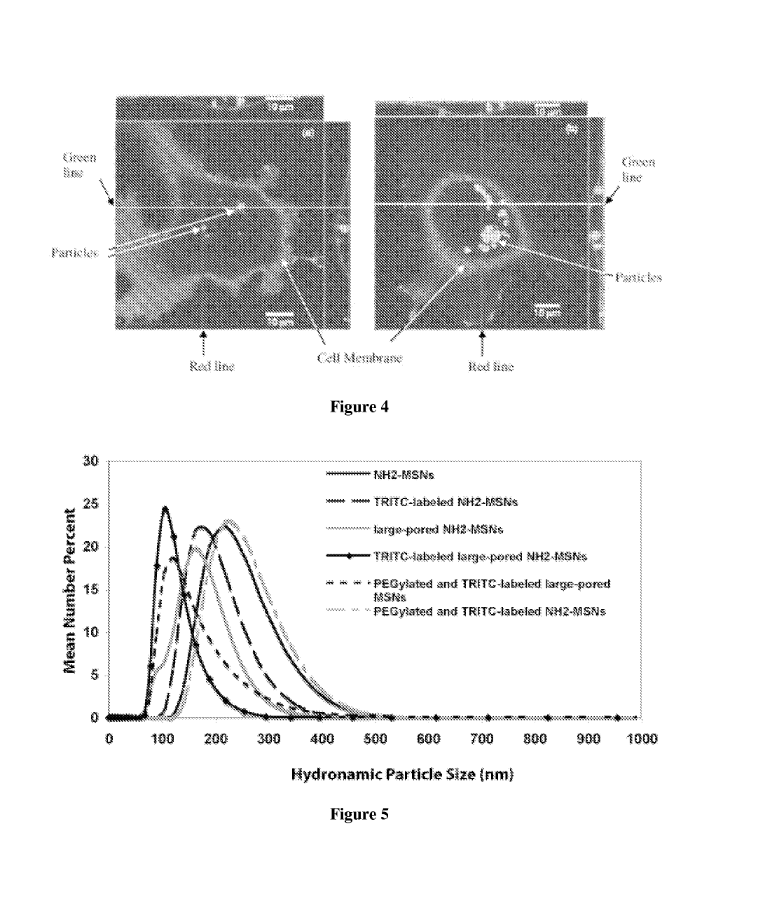

Additional PEGylation with poly(ethylene glycol) succinimidyl succinate (PEG) prevented particle aggregation, providing good stability in physiological environments. The change in zeta potentials before and after PEGylation from 36.5±6 mV to −0.5±5 mV for TRITC-labeled NH₂-MSNs and from 32±6 mV to 6±4 mV for TRITC-labeled large-pore NH₂-MSNs confirmed the surface modifications. At the same time through PEGylation, the hydrodynamic particle sizes as determined by DLS slightly increased for both samples (see Table 1). Confocal microscopy experiments confirm the uptake of normal and large-pore NH₂-MSNs into COS-7 and endothelial cells, respectively. FIGS. 4a and b illustrate the spontaneous cell uptake of PEGylated and TRITC-labeled NH₂-MSNs from the medium and accumulation into discrete cytosolic structures. Cell cross-section images along two orthogonal directions and obtained from z-scans in the microscope shown at the top and on the right confirmed the presence of particles inside cells, most likely in endosomes. The size of particles used in the presented experiments was consistent with fluid phase endocytosis as the main particle uptake pathway. It is interesting to note that no particle aggregation was observed on the cell membrane consistent with successful PEGylation.

### EXAMPLE 2

This example demonstrates the synthesis and characterization of mesoporous nanoparticles.

Synthesis of aminated mesoporous silica nanoparticles (NH₂-MSNs). Ethyl acetate (EtOAc), ammonium hydroxide (NH₄OH), and a mixture of silane precursors (tetraethyl orthosilicate (TEOS) and 3-aminopropyl triethoxysilane (APTES)) were added into an aqueous solution of hexadecyltrimethylammonium bromide (CTAB) (54.8 mM) and stirred for 5 minutes. Additional water was then added into the reaction before leaving the solution overnight under stirring. The pH of the solution at this point was around pH=11. The molar composition of chemicals used was 1 CTAB:3.68 TEOS:4.29 APTES:150.73 NH₃:32.81 EtOAc:28759.12 H₂O. The volume ratio of all compounds in milliliters was 1 CTAB (aq):0.045 TEOS:0.055 APTES:0.54 NH₄OH:0.176 EtOAc:27.38 H₂O. The resulting solution was slightly translucent. After 24 hours, the reaction solution was neutralized using hydrochloric acid solution (2 M). Every step was performed at room temperature. The sample was cleaned by centrifugation and redispersed in ethanol. Two methods were used to remove CTAB: (a) acid extraction using an acetic acid/ethanol mixture (95/5 v/v) by stirring cleaned as-made materials in acid solution for 30 minutes, before centrifugation to remove CTAB and acetic acid, and (b) calcination in air at 540° C. for 6 hours. The samples with these different treatments are referred to, in this example, as acid-extracted and calcined materials, respectively.

Synthesis of large-pore NH₂-MSNs. In general, the preparation and chemical concentrations used were similar to the synthesis protocol of NH₂-MSNs, except the presence of 1,3,5-trimethylbenzene (TMB). After the addition of EtOAc and NH₄OH, TMB was added into the CTAB aqueous solution. The solution was stirred for 30 minutes before adding a mixture of silane precursors. The molar composition of chemicals used was 1 CTAB:3.68 TEOS:4.29 APTES:150.73 NH₃:32.81 EtOAc:18.68 TMB:28759.12 H₂O. The volume ratio of all compounds in milliliters was 1 CTAB (aq):0.045 TEOS:0.055 APTES:0.54 NH₄OH:0.176 EtOAc:0.142 TMB:27.38 H₂O. The subsequent steps were identical to what has been described in the previous paragraph.

Synthesis of TRITC-labeled NH₂-MSNs. Tetramethyl rhodamine isothiocyanate (TRITC) (5.6 mM in dimethyl sulfoxide) was conjugated to APTES with 1:25 (TRITC:APTES) molar ratio while stiffing in a nitrogen atmosphere glove box overnight before use. Fluorescent mesoporous silica nanoparticles were prepared in a manner identical to the synthesis of NH₂-MSNs, with the exception that conjugated TRITC (90 μL) was added 1 minute before the addition of silane precursors.

Synthesis of TRITC-labeled large-pore NH₂-MSNs. The preparation and chemical concentrations used were identical to the synthesis protocol of large-pore NH₂-MSNs, except that 1 minute before the addition of silane precursors the conjugated TRITC was added (see previous paragraph).

Surface modifications of TRITC-labeled NH₂-MSNs and TRITC-labeled large-pored NH₂-MSNs with poly(ethylene glycol). Poly(ethylene glycol)-succinimidyl succinate (5 mg; MW 5000) was dissolved in ethanol (48 mL) at 40° C. for 3-5 minutes until a clear solution was formed. Suspension of acid-extracted TRITC-labeled silica particles (5 mg) in ethanol (2 mL) was added into the PEG solution preheated to 40° C. The reaction solution was kept at 40° C. for 3 hours to allow the reaction between amine groups on the particle surface and succinimidyl ester groups to complete. The resulting product was cleaned by centrifugation and redispersion in ethanol and water to remove excess or unreacted PEG molecules.

Characterization. Transmission electron microscopy (TEM) images were obtained with a PEI Tecnai T12 Spirit microscope operated at an acceleration voltage of 120 kV. Average particle sizes were obtained by averaging over approximately 100 particles. Hydrodynamic particle sizes, particle size distributions, and zeta potentials in water were measured on a Malvern Zetasizer Nano-SZ. Hydrodynamic particle sizes and particle size distributions based on the mean number percents were used in this study. Small-angle x-ray scattering (SAXS) patterns of calcined NH₂-MSNs and acid-extracted large-pore NH₂-MSNs were obtained on a home-built beamline as described with a sample-to-detector distance of 25 cm, whereas SAXS patterns of acid-extracted NH₂-MSNs, acid-extracted TRITC-incorporated NH₂-MSNs, and acid-extracted TRITC-labeled large-pore NH₂-MSNs were obtained at the G1 beamline in the Cornell High Energy Synchrotron Source (CHESS) with a beam energy of 9.5 keV and a sample to detector distance of 35 cm. All samples were in dry forms. Nitrogen physisorption isotherms of dried samples were obtained with a Micromeritics ASAP2020 physisorption instrument. The particles exhibited nitrogen sorption isotherms of type IV according to BDDT classification. Surface areas were determined according to the Brunauer-Emmett-Teller (BET) method. The BET surface area analysis was performed in the range between 0.042 and 0.095. Calculation of the pore size distributions from the adsorption branches of the isotherms was performed according to the Barrett-Joyner-Halenda (BJH) method. Noted is the fact that this method is known to underestimate the pore size distribution for materials with spherical pores below 10 nm in diameter. Thus, the geometrical model of a Pm 3̅n cage-like mesoporous material was applied and estimated the pore size from the mesopore volume and the lattice constants obtained by SAXS (see Table 4). Fourier Transform Infrared (FTIR) spectra were measured with Bruker Optics-Vertex 80V equipped with a transmission holder under vacuum. FTIR spectra were collected in the frequency range of 4000-400 cm⁻¹ for 128 scan, 4 cm⁻¹. Analyses were performed on KBr (blank) pellet and sample pellets containing 1 wt % samples in KBr. All elemental analyses were conducted by Galbraith Laboratories, Inc., Knoxville, Tenn. Thermogravimetric analysis (TGA) was conducted on a TA instruments Q500 thermogravimetric analyzer. All measurements were taken from room temperature to 650° C. under a nitrogen flow.

For cell uptake experiments, each PEGylated and TRITC-labeled mesoporous silica sample was studied on different cell types, i.e. PEGylated and TRITC-labeled NH₂-MSNs were incubated with COS-7 cells (simian kidney cells) and PEGylated and TRITC-labeled large-pore NH₂-MSNs were incubated with epithelial cells (SLC-44, fetal rat intestinal epithelial cells). COS-7 cells (or epithelial cells) were plated on MatTek coverslip dishes in complete medium over night in the presence of suspended MSN samples. Prior to imaging, cells were washed 3 times with buffered salt solution (BSS: 135 mM NaCl, 5 mM KCl, 1.8 mM CaCl₂, 1 mM MgCl₂, 1 mg/ml glucose, 20 mM Hepes, pH=7.2-7.4, 1 mg/ml BSA) to remove free-floating and loosely absorbed particles, and incubated for 5 minutes with a far-red plasma membrane dye (Cell Mask Deep Red, Molecular Probes, Em/Ex 660/677 nm). The uptake and distribution of the particles was then investigated using confocal microscopy (Zeiss 510 Meta LSM). Cells in dishes were mounted on a 40× oil immersion objective for detection of TRITC labeled particles. Images were processed using Zeiss LSM software.

Structure Analysis. The symmetry assignment for NH₂-MSN materials based on the analysis of 1-dimensional (1-D) SAXS scaterring patterns shown in FIG. 2 is described below. From the TEM images which show four-fold as well as three-fold symmetry projections (FIGS. 1b and c, respectively), we started the analysis with the assumption that NH₂-MSNs possess a cubic lattice. To extract peak positions, integrated 1-D SAXS patterns, shown in FIG. 2, were first treated with background subtraction by fitting a power-law curve.

The peak positions were then determined by finding the local minima of the second-order difference of the intensity, I(q). In this way, it was revealed that there is also a small (110) peak in the scattering data. FIG. 7 shows the correlation between s=(h²+k²+l²)^{1/2}, where h, k and l are the three cubic indices assignments, and the observed peak positions for the acid-extracted NH₂-MSN sample. The observed peak positions correlate linearly with the lattice indices assignments if we assign the first peak to be from (110) reflection. Note that the existence of the 9^{th} peak (q=0.2445 Å⁻¹) does not allow the first peak to be (200) since this will assign the above peak at h²+k²+l²=28, for which no such combination of lattice indices h, k and l exists. Similarly, the possibility that the first peak is (211) is excluded because of the existence of the 3^{rd} peak (q=0.1462 Å⁻¹).

Based on these reflection plane assignments, we proceeded with determining the cubic symmetry aspects. Table 2 shows the list of observed reflections and the comparison with cubic symmetry aspects that show allowed reflections at h²+h²+l²=4, 5, and 6. The observed reflections match that of symmetry aspect 5 up to (400) reflection planes, and thus we can conclude that the material possesses a cubic symmetry aspect 5. Structure factor analysis for determining the exact nature of structure such as porosity and pore interconnectivity were not performed due to large background scattering signal.

TABLE 1
Table of Particle Sizes and Size Distributions Measured by DLS
and TEM as well as Zeta Potentials of Acid-Extracted MSNs.

| | | | Zeta |
|---|---|---|---|
| | Particle Size (nm) | | Potential |
| Samples | DLS* | TEM | (mV) |
| NH₂-MSNs | 220.2 | 223.1 ± 49.3 | 42.1 ± 4.96 |
| TRITC-labeled NH₂-MSNs | 190.1 | 214 ± 43.7 | 36.5 ± 5.97 |
| PEGylated TRITC-labeled | 220.2 | n/a | −0.55 ± 5.17 |
| NH₂-MSNs | | | |
| Large-pored NH₂-MSNs | 164.2 | 108.2 ± 24.1 | 43 ± 6.38 |
| TRITC-labeled | 105.7 | 94.8 ± 15.7 | 32 ± 5.97 |
| large-pored NH₂-MSNs | | | |
| PEGylated TRITC-labeled | 122.4 | n/a | 6.48 ± 3.93 |
| large-pored NH₂-MSNs | | | |

*DLS: Hydrodynamic particle sizes measured by dynamic light scattering (DLS) technique using Malvern Zetasizer Nano-SZ.

TABLE 2
Table of comparison between the observed reflections of NH₂-MSNs
and the allowed reflections for cubic symmetry aspects that include h² + k² + l² = 4, 5, and 6.
Peaks in parentheses are weak peaks that are only extracted after subtracting the background
and taking the 2^{nd} order difference of the integrated 1D SAXS patterns. The list of allowed
reflections for different cubic symmetry aspects are taken from the literature.

| h² + k² + l² | 1 | 2 | 3 | 4 | 5 | 6 | 8 | 9 | 10 | 11 | 12 | 13 | 14 | 16 | 17 | 18 | 19 | 20 | 21 | 22 | 24 | 25 |
|---|---|---|---|---|---|---|---|---|---|---|---|---|---|---|---|---|---|---|---|---|---|---|
| Obs. | | (+) | | + | + | + | (+) | | + | | + | + | + | + | | | | + | + | | | |
| aspects | | | | | | | | | | | | | | | | | | | | | | |
| 1 | + | + | + | + | + | + | + | + | + | + | + | + | + | + | + | + | + | + | + | + | + | + |
| 2 | − | + | + | + | + | + | + | + | + | + | + | + | + | + | + | + | + | + | + | + | + | + |
| 5 | − | + | − | + | + | + | + | − | + | − | + | + | + | + | + | + | − | + | + | + | + | + |
| (P 4̅3n, Pm 3̅n) | | | | | | | | | | | | | | | | | | | | | | |
| 7 | − | − | + | + | x | + | + | + | − | + | + | x | + | + | + | + | − | + | + | + | + | x |

TABLE 3
Table of C, H, N and Si contents of acid-extracted NH₂-MSNs and
acid-extracted large-pored NH₂-MSNs from elemental analysis.

| | Weight %^{a} | | | | |
|---|---|---|---|---|---|
| Samples | C | H | N | Si | Mol %^{b} |
| NH₂-MSNs | 13.36 | 4.275 | 3.108 | 30.4 | 19.27 |
| large-pored NH₂-MSNs | 12.79 | 3.599 | 3.598 | 30.7 | 22.43 |

^{a}mass of analyzed NH₂-MSNs for elemental analysis of CHN and Si were 2.094 mg and 31.32 mg, respectively. Mass of analyzed large-pored NH₂-MSNs for elemental analysis of CHN and Si were 2.313 mg and 40.51 mg, respectively.
^{b}mol % of N in analyzed samples compared with the initial loading concentrations of total silane.

Calculation Method:

Assume all TEOS completely underwent reactions, N_{APTES} and N_{TEOS} are the number of moles of APTES and TEOS fed into the synthesis, respectively. N′_{APTES} is the number of moles of APTES that were in the final product.

For NH₂-MSNs,

$$\begin{matrix}\begin{matrix}starting \text{:} & \frac{{N}_{APTES}}{{N}_{TEOS} + {N}_{APTES}} = \frac{27}{50}\end{matrix} & ( 1 ) \\ \begin{matrix}final \text{:} & \frac{{N}_{APTES}^{′}}{{N}_{TEOS} + {N}_{APTES}^{′}} = \frac{3.108 / 14.0067}{30.4 / 28.0855} = \frac{6.232}{30.4}\end{matrix} & ( 2 ) \\ \begin{matrix}( 1 ) ; & \frac{50}{27} {N}_{APTES} = {N}_{TEOS} + {N}_{APTES}\end{matrix} & ( 3 ) \\ \begin{matrix}( 2 ) ; & \frac{30.4}{6.232} {N}_{APTES}^{′} = {N}_{TEOS} + {N}_{APTES}^{′} \\ ( 3 ) - ( 4 ) ; & 1.85 {N}_{APTES} - 4.88 {N}_{APTES}^{′} = {N}_{APTES} - {N}_{APTES}^{′} \\ & 0.85 {N}_{APTES} = 3.88 {N}_{APTES}^{′} \\ & {N}_{APTES}^{′} = 0.219 \times 54 = 11.83\end{matrix} \\ mol \% of A P T E S w . r . t . total silane in final product = ( \frac{11.83}{46 + 11.83} ) \times 100 = 20.45 mol \% . & ( 4 )\end{matrix}$$

TABLE 4
Estimated spherical cavity size (Dₘₑ) and average wall thickness
(h) for each NH₂-MSN sample. The cubic lattice constant, a, is determined
from SAXS, and the mesoporosity, εₘₑ, is estimated from the
nitrogen sorption profile as described below.

| | | | Large-pored | |
|---|---|---|---|---|
| | NH₂-MSN | | NH₂-MSN | Large-pored |
| | (acid- | NH₂-MSN | (acid- | NH₂-MSN |
| | extracted) | (calcined) | extracted) | (calcined) |
| a [nm] | 9.61 | 8.96 | 14.57 | 13.90 |
| εₘₑ | 0.2457 | 0.2259 | 0.4854 | 0.4394 |
| Dₘₑ [nm] | 3.73 | 3.39 | 7.10 | 6.56 |
| h [nm] | 3.82 | 3.87 | 2.51 | 2.79 |
| BJH model [nm] | 2.7 | 2.7 | 5.3 | 5.0 |

Calculation Method:

Here we only show the calculations on the cavity size and wall thickness for the acid-extracted NH₂-MSNs (without TMB). The lattice constant for the acid-extractred NH₂-MSNs is measured to be a=9.6 nm from SAXS. For nitrogen sorption profiles, since the lower plateau of the nitrogen sorption is not well-defined, we took the volume of condensed nitrogen adsorbed at p/p₀=0.2 as the micropore volume V_{micro} (8.586 mmol/g). The upper plateau of the nitrogen sorption was defined at the volume of condensed nitrogen adsorbed at p/p₀=0.9 to give the total pore volume, Vₜₒₜₐₗ (15.649 mmol/g).

The mesoporosity of the material, εₘₑ, can then be calculated from:

$$\begin{matrix}{ɛ}_{me} = \frac{{ρ}_{V} ( {V}_{total} - {V}_{micro} )}{1 + {ρ}_{V} {V}_{tot}} \\ = 0.2457\end{matrix}$$

where ρν is the bulk density of the solid, which was assumed to be 2.2 g/cm³ for the silica walls. Assuming Pm 3̅n symmetry and a cage-like spherical pore structure with the number of cavities per unit cell=8, the sphere diameter Dₘₑ can be calculated as:

$$\begin{matrix}{D}_{me} = {a ( \frac{6}{π} \frac{{ɛ}_{me}}{v} )}^{1 / 3} \\ = 3.73 nm ..\end{matrix}$$

The average wall thickness for this material, h, can be calculated as:

$$\begin{matrix}h = \frac{{D}_{me}}{3} \frac{1 - {ɛ}_{me}}{{ɛ}_{me}} \\ = 3.82 nm ..\end{matrix}$$

Table 4 lists estimates for spherical cavity size, Dₘₑ, and average wall thickness, h, of the NH₂-MSN samples (as well as large pored NH₂-MSN samples) derived from these calculations. Mean pore size estimates from the BJH model are also listed. Comparison of the results suggests that the BJH model may underestimate the pore size of the normal and large-pore NH₂-MSN samples by about 1 and 1-2 nm, respectively.

### EXAMPLE 3

This example demonstrates the room temperature formation of aminated mesoporous silica nanoparticles (NH₂-MSNs) by means of co-condensation of different molar ratios of tetraethyl orthosilicate (TEOS) and 3-aminopropyl triethoxysilane (APTES) in the synthesis feed. The resulting materials were characterized by a combination of transmission electron microscopy (TEM), small-angle X-ray scattering (SAXS), Fourier transform infrared (FTIR) spectroscopy, thermogravimetric analysis (TGA), and N₂ adsorption/desorption measurements. Analysis revealed that an increase in APTES loading (mol %) leads to structural transitions in the MSNs from hexagonal (0-49 mol %) to cubic Pm 3̅n (54-64 mol %) to disordered at very high APTES amounts (69 mol %). Investigation of structural evolution during cubic Pm 3̅n particle synthesis revealed early particle formation stages that are surprisingly similar to those discussed in recent literature on nonclassical single crystal growth. These include significant heterogeneities in particle density despite crystallographic orientation across the entire particle as well as particle growth via addition of preformed and prestructured silica clusters. Syntheses at varying pH reveal further details of the structure formation process. The results pose fundamental questions about the relation between formation mechanisms of classical crystalline materials and mesoscopically ordered, locally amorphous materials.

Materials. Hexadecyltrimethylammonium bromide (approximately 99%), ethyl acetate (EtOAc, ACS grade), tetraethyl orthosilicate (TEOS, ≧99%, GC), (3-aminopropyl)triethoxysilane (APTES, >95%), ammonium hydroxide (NH₄OH, 29%), acetic acid (glacial), hydrochloric acid (36.5-38%), ethanol (absolute, anhydrous), and deionized water (Milli-Q, 18.2 MΩ-cm) were used as obtained without further purification.

Synthesis. Synthesis of Aminated Mesoporous Silica Nanoparticles from Different APTES Concentrations. EtOAc, NH₄OH, and a mixture of silane precursors (TEOS and APTES) were sequentially added into an aqueous solution of hexadecyltrimethylammonium bromide (CTAB) (54.8 mM) and stirred for 5 minutes. Additional water was then added into the reaction before leaving the solution overnight under stiffing. After 24 hours, the reaction solution was neutralized using hydrochloric acid solution (2 M). The sample was cleaned by centrifugation and redispersed in ethanol. CTAB was removed by acid extraction using an acetic acid/ethanol mixture (95/5 v/v). Samples were stirred for 30 minutes, before centrifugation to remove CTAB and acetic acid. Every step was performed at room temperature. In this example, we will refer to these materials as X—NH₂-MSNs, where X is the mol % of APTES (with respect to total silane used) loaded in the synthesis. The amount of TEOS and APTES were varied, while all other chemicals were kept constant for all samples. For example, the volumetric ratio in milliliters of chemicals used in the synthesis of 54-NH₂-MSNs was 1 CTAB (aq):0.045 TEOS:0.055 APTES:0.54 NH₄OH:0.176 EtOAc:27.38 H₂O If not stated otherwise, the concentration of NH₄OH in the synthesis was 207.5 mM.

Control samples were prepared in the same way as described for the synthesis of NH₂-MSNs but without the addition of APTES.

To investigate the effect of solution pH on the structure of mesoporous silica with 54 mol % APTES loading, concentrations of NH₄OH were varied. In addition to a concentration of 207.5 mM used in the syntheses described above, two further concentrations of NH₄OH, i.e., 103.75 and 409 mM, were chosen.

Particle Characterization. After CTAB removal by acid extraction (vide supra) all samples were dried under vacuum. Transmission electron microscopy (TEM) images of dried samples were obtained with a FEI Tecnai T12 Spirit microscope operated at an acceleration voltage of 120 kV. Two-dimensional (2D) SAXS patterns of dried samples were obtained with a CCD X-ray detector on a home-built beamline as described with a sample-to-detector distance of 25 cm and at the G1 beamline at the Cornell High Energy Synchrotron Source (CHESS) with a beam energy of 9.5 keV and a sample to detector distance of 35 cm. Azimuthal integration of the 2D SAXS patterns around beam centers yielded one-dimensional (1D) SAXS patterns. Low contrast in both, TEM images as well as SAXS scattering patterns, rendered material analysis before template removal challenging, which is why it was not pursued in this study. While structural changes upon surfactant removal and drying are unlikely based on results of earlier studies on the formation mechanism of hexagonal MSNs, we note here that they cannot be completely excluded.

Nitrogen physisorption isotherms of dried samples were obtained with a Micromeritics ASAP2020 physisorption instrument. The particles exhibited nitrogen sorption isotherms of type IV according to BDDT classification. Surface areas were determined according to the Brunauer-Emmett-Teller (BET) method. The BET surface area analysis was performed in the range between 0.042 and 0.095. Calculation of the pore size distributions from the adsorption branches of the isotherms was performed according to the Barrett-Joyner-Halenda (BJH) method and a geometrical model. Thermogravimetric analysis (TGA) was conducted on a TA Instruments Q500 thermogravimetric analyzer. All measurements were taken from room temperature to 650° C. under nitrogen flow. Infrared spectra were measured on a Bruker Optics-Vertex 80 V equipped with a transmission holder under vacuum. FT-IR spectra were recorded in the frequency range of 4000-400 cm⁻¹, and 128 scans at a resolution of 4 cm⁻¹ were collected for one spectrum. Measurements were performed on KBr (blank) pellets and sample pellets containing 1 wt % samples in KBr.

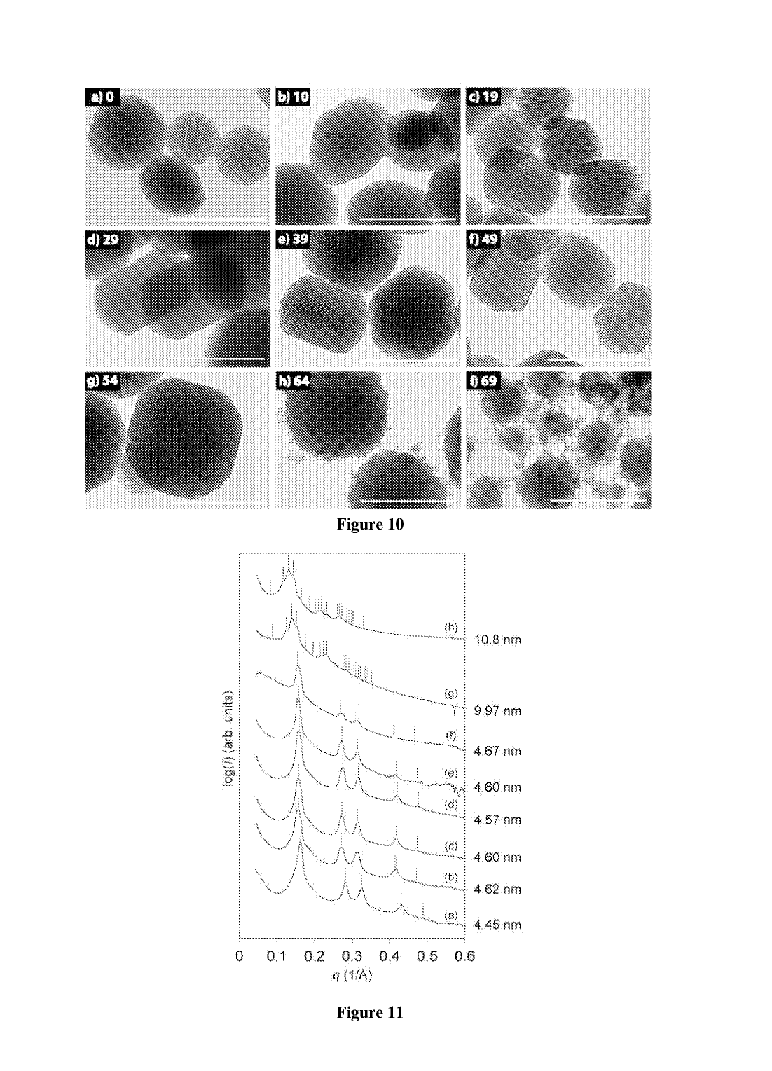

Aminated Mesoporous Silica Nanoparticles from Different Amounts of APTES. Incorporating organic moieties into mesoporous silica particles via co-condensation of different types of silane precursors is often used as it is a simple one-pot process and is expected to provide a uniform distribution of organic functionality. In the present work, NH₂-MSNs obtained from different amounts of APTES (10-69 mol %) in the synthesis feed were prepared in this way at room temperature using APTES and TEOS as precursors. FIG. 10(a-i) shows TEM images of control and X—NH₂-MSNs after removal of CTAB. As the amount of APTES in the starting solutions increased, the structure of the resulting NH₂-MSNs changed from what looks like hexagonal (FIG. 10(a-f), 0-49 mol %) to cubic (FIG. 10(g-h), 54-64 mol %) and finally to disordered structures (FIG. 10i, 69 mol %). At the same time the shapes of particles varied from oval-like in the control samples to one-dimensionally elongated particles in the presence of moderate amounts of APTES (10-49 mol %). A further increase in the amount of APTES led to the formation of octahedrally truncated particles at 54 mol % and cube-like shapes at 64 mol % APTES. Comparing TEM images of 54- and 64-NH₂-MSNs (FIG. 10(g-h)) reveals that while both samples are similar in shape and structure, 64-NH₂-MSNs have less facets and a rough surface from additional small silica nanoparticles. At even higher concentrations of APTES (see FIG. 10i, 69 mol % APTES), the resulting materials are disordered and irregular in shape. Clusters of silica nanoparticles around the larger porous particles are observed, suggesting that the particle formation under these conditions is retarded. In addition, the yield for this reaction was very low. Based on the TEM analysis the presence of increasing amounts of APTES leads to two major effects: i) APTES molecules induce a transformation of particle structure and shape and ii) together with the room temperature synthesis conditions of MSNs large amounts of APTES slow down the rate of particle formation.

The transformation of particle structure as a function of APTES amounts in the synthesis feed was corroborated by SAXS measurements. While the limited number of reflections and the powder nature of the SAXS patterns introduce possibilities of mixed morphologies or inhibit definitive structure assignments in some cases, they show the evolution and transformation of internal structures as an ensemble average. SAXS scattering patterns shown in FIG. 11 were taken from dried samples after removal of surfactant templates by acid extraction. Here, q denotes the scattering vector and is defined as q=(4π sin θ)/λ, with a scattering angle 2θand the X-ray wavelength, λ=1.54 Å. SAXS data are consistent with a hexagonal lattice for samples made from 0 to 49 mol % APTES in the reaction feed as indicated by a set of peaks at q=0.16, 0.27 (0.28 for control), 0.31 (0.32 for control), and 0.41 (0.43 for control) Å. These reflections can be indexed as {10}, {11}, {20}, and {21} reflections. Samples of 49-NH₂-MSN only showed 3 peaks indexed as {10}, {11}, and {20}. In SAXS diffractograms of 54- and 64-NH₂-MSNs, six well-resolved peaks are observed. They can be indexed as {200}, {210}, {211}, {222}, {320}, and {321} reflections of a cubic lattice with Pm 3̅n symmetry. Thus, even though the TEM image of 64-NH₂-MSNs (FIG. 10h) does not exhibit well-defined particle shapes as observed for sample 54-NH₂-MSN (FIG. 10g), the SAXS scattering patterns of both samples point to the same structure. Higher ordered peaks of 64-NH₂-MSNs were slightly shifted to lower q values as compared to those of 54-NH₂-MSNs. Both TEM and SAXS analyses consistently suggest a morphology transition upon the addition of more and more APTES in the reaction feed, implying that the organization of surfactant molecules into micelles or silane-surfactant micelle complexes is affected by the presence of organosilane, APTES.

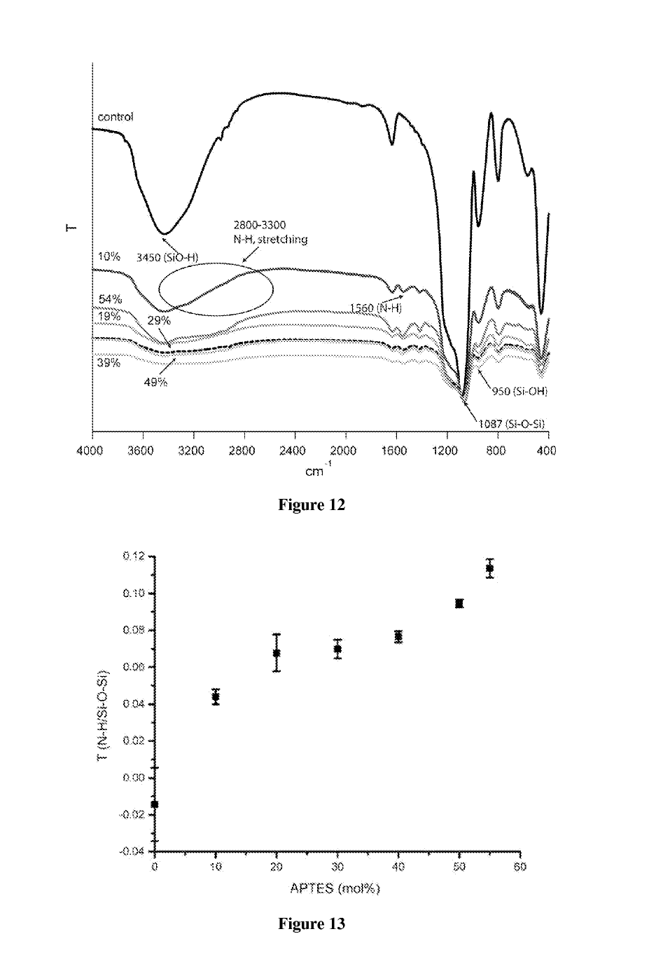

To qualitatively determine the amount of APTES incorporated in the organically modified mesoporous particles, FTIR spectroscopy and TGA were conducted on control and X—NH₂-MSNs, where X=10-54 mol %, after CTAB removal. Specific peaks in FTIR spectra are evidence for the presence of specific organic functionalities, and the corresponding intensities are a measure of their relative abundance. In this way, FTIR spectra can qualitatively indicate the amount of APTES integrated into the silica framework. FTIR spectra of control and X—NH₂-MSNs after normalization to the Si—O—Si peak at 1087 cm⁻¹ of the control sample are shown in FIG. 12. The spectrum of the control sample has high intensity peaks at 948 and 3450 cm⁻¹ (SiO—H) and at 1087 cm⁻¹ (Si—O—Si). The intensities of these peaks become lower in amine-containing materials. All aminated materials exhibit the appearance of additional peaks at 1560 and very broad peaks from 2800 to 3300 cm⁻¹ characteristic for the N—H bending and stretching vibrations of primary amines, respectively. This indicates the presence of APTES in the acid-treated NH₂-MSNs. In addition, the peak around 1420 cm⁻¹ can be attributed to the bending vibration of either ammonium ion N⁺—H bonds or the methylene C—H bonds. To semiquantitatively analyze APTES content between samples, we compared the peak intensities of the N—H bending vibration at 1560 cm⁻¹ relative to those of Si—O—Si at 1087 cm⁻¹ in the same sample. FIG. 13 presents the plot of peak ratio of the N—H bending/Si—O—Si stretching for different mol % of APTES in the synthesis. As expected, the peak ratio monotonically increases with the feed concentration of APTES, suggesting that the amount of APTES co-condensed with TEOS is roughly proportional to the initial concentration.

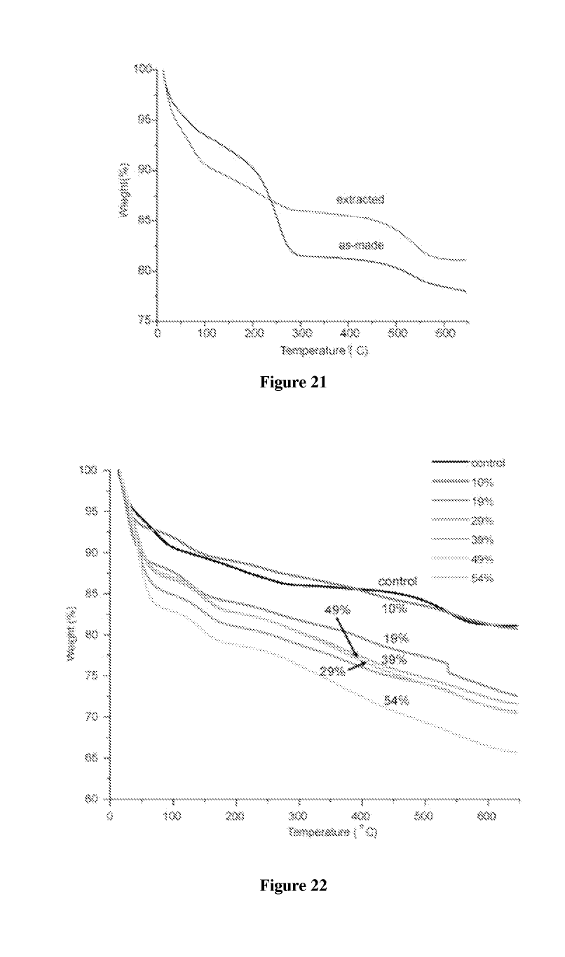

Thermogravimetric measurements of all acid-extracted samples were conducted from room temperature to 650° C. under nitrogen flow. TGA curves of control samples (0-NH₂-MSNs) before and after template removal are presented in FIG. 21. As-made MSNs exhibited a weight loss of about 7% at temperatures lower than 120° C., attributed to the loss of small amounts of residual ethanol and moisture adsorbed on the materials surface. This initial weight loss is followed by a 10-12% weight loss from 120 to 300° C. due to surfactant decomposition. At even higher temperatures around 450-600° C., there was another weight loss of 2-4%, which most likely comes from further co-condensation of the silica matrix. After CTAB removal, the TGA curve of MSNs showed a similar temperature dependence, except that the weight loss around 250° C. with only 3% was significantly reduced, as expected after template removal. The weight loss curves of different acid-extracted NH₂-MSNs shown in FIG. 22 also all exhibited three different decomposition steps albeit with different temperature dependence. Most importantly, the decomposition temperature range associated with APTES is very broad from about 250-600° C. In general, the three weight loss regimes observed in the TGA profiles most likely originate from (i) loss of ethanol and moisture (20-80° C.), (ii) residual CTAB removal/decomposition (80-150° C.), and (iii) APTES decomposition plus dehydration of surface hydroxyl groups (>250° C.). The large amount of weight loss at temperatures below about 100° C. most likely reflects the increasing hydrophilicity of the materials with increasing APTES content. The residual weight (%) at 645° C. (see Table 5) relates qualitatively to the loading concentration of APTES.

TABLE 5
BET Surface Area, BJH Pore Size, SAXS Unit Cell Size (a), and
Residual Inorganic Weight Percentage Determined by Thermogravimetric
Analysis of Acid-Extracted Control Samples and NH₂-MSNs Obtained
from Different mol % APTES in the Reaction Feed

| | | | N₂ sorption | | |
|---|---|---|---|---|---|
| | | | BET | BJH | |
| | APTES | | surface | pore | wt % |
| samples | (mol %)^{a} | a (nm) | area (m²/g) | size (nm) | residue^{d} |
| control | 0 | 4.45^{b} | 1123 | 2.7 | 81.1 |
| 10-NH₂-MSN | 9.6 | 4.62^{b} | 798 | 2.6 | 80.7 |
| 19-NH₂-MSN | 19.2 | 4.60^{b} | 984 | 2.6 | 72.5 |
| 29-NH₂-MSN | 29.0 | 4.57^{b} | 894 | 2.3 | 70.6 |
| 39-NH₂-MSN | 38.9 | 4.60^{b} | 812 | 2.7 | 71.6 |
| 49-NH₂-MSN | 48.8 | 4.67^{b} | 807 | 2.7 | 70.5 |
| 54-NH₂-MSN | 53.8 | 9.97^{c} | 674 | 2.7 | 65.6 |
| 64-NH₂-MSN | 63.9 | 10.8^{c} | 458 | n/a | n/a |
| 69-NH₂-MSN | 69.0 | n/a | n/a | n/a | n/a |

^{a}Mol % of APTES loaded in synthesis conditions.
^{b}Unit cell calculated from a = 4π/√3q* where q* = qₕₖ/(h² + k² + hk)^{1/2}.
^{c}Unit cell calculated from a = 2π/q* where q* = qₕₖₗ/(h² + k² + l²)^{1/2}.
^{d}Weight percentage of residue at 645° C. determined by thermogravimetric analysis.

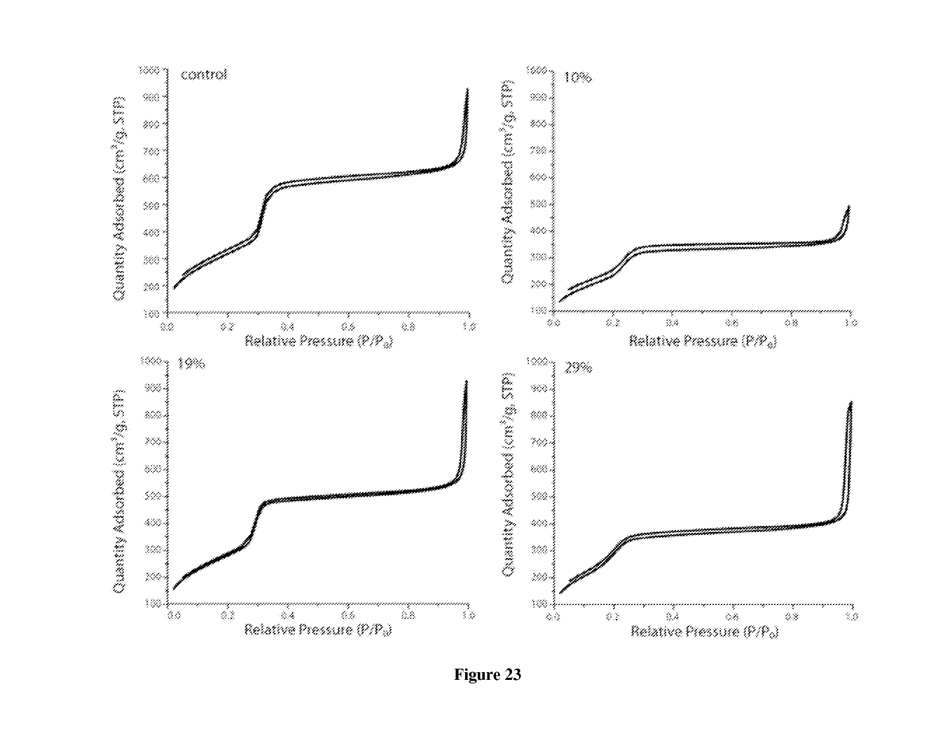

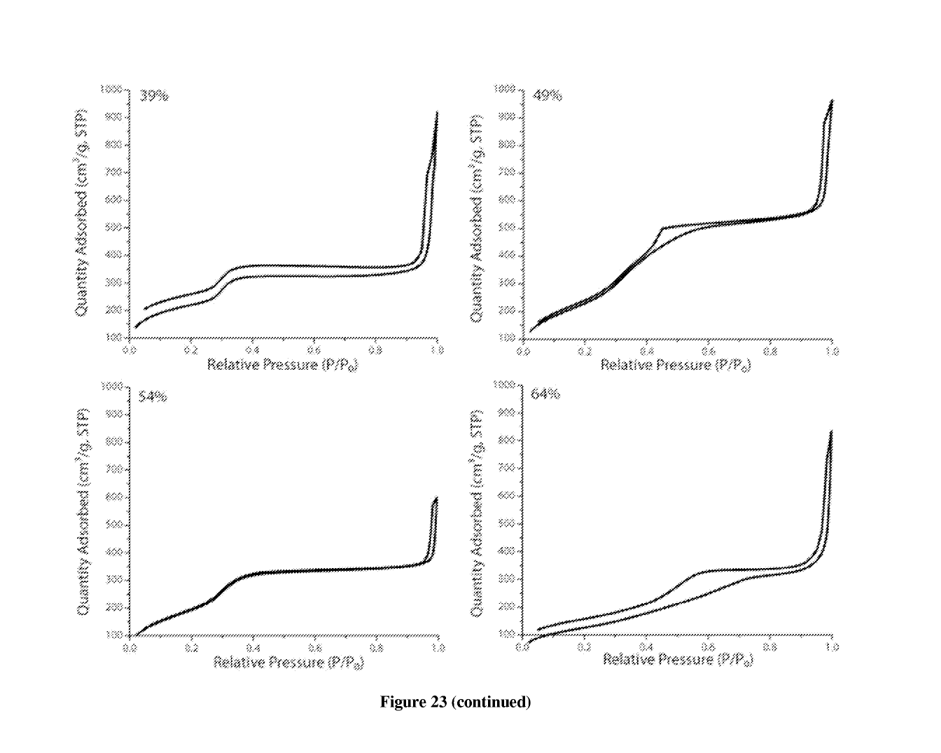

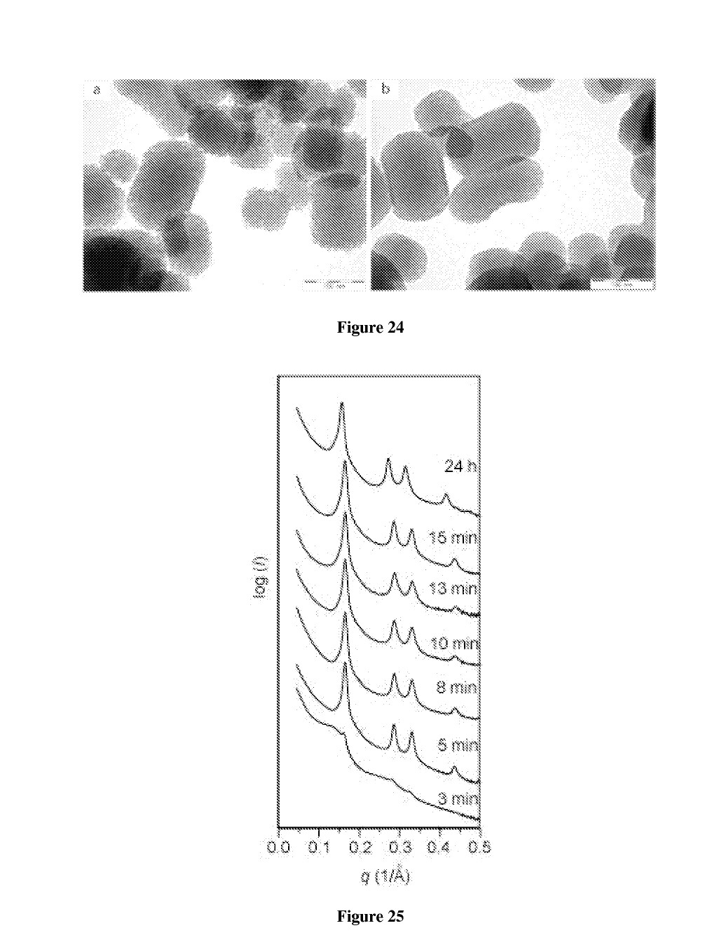

Nitrogen sorption measurements were performed on acid-extracted materials (Table 5). All samples exhibit type IV isotherms (see FIG. 23) with no or small hysteresis. Compared to the control (0-NH₂-MSNs), the addition of APTES results in a decrease in BET surface area for all NH₂-MSNs as previously reported for organically modified mesoporous silica. BJH pore sizes are similar for all samples irrespective of structure, except for sample 29-NH₂-MSNs, which for unknown reasons shows somewhat smaller pores, reflecting the difference in the sorption curve inflection point around p/p₀=0.2 to 0.3. The BJH model assumes cylindrical pores and thus underestimates the true cavity size of mesoporous materials exhibiting cubic Pm 3̅n structure. Table 6 shows the estimated spherical cavity size of 54-NH₂-MSNs as 3.87 nm as derived from a geometrical model. The pore size of 64-NH₂-MSNs could not be determined. A significant decrease in BET surface area for 64-NH₂-MSNs might be due to the presence of small silica nanoparticles around larger mesoporous particles as observed in TEM.

TABLE 6
Estimated Spherical Cavity Size (Dₘₑ) and Average
Wall thickness (h) for 54-NH₂-MSN Sample^{a}

| | a [symbol] (nm) | εₘₑ | Dₘₑ (nm) | h (nm) |
|---|---|---|---|---|
| 54-NH₂-MSN | 9.97 | 0.2457 | 3.87 | 3.96 |

^{a}The cubic lattice constant, a, was determined from SAXS, and the mesoporosity, εₘₑ, was estimated from the nitrogen adsorption profile. [symbol]
indicates data missing or illegible when filed

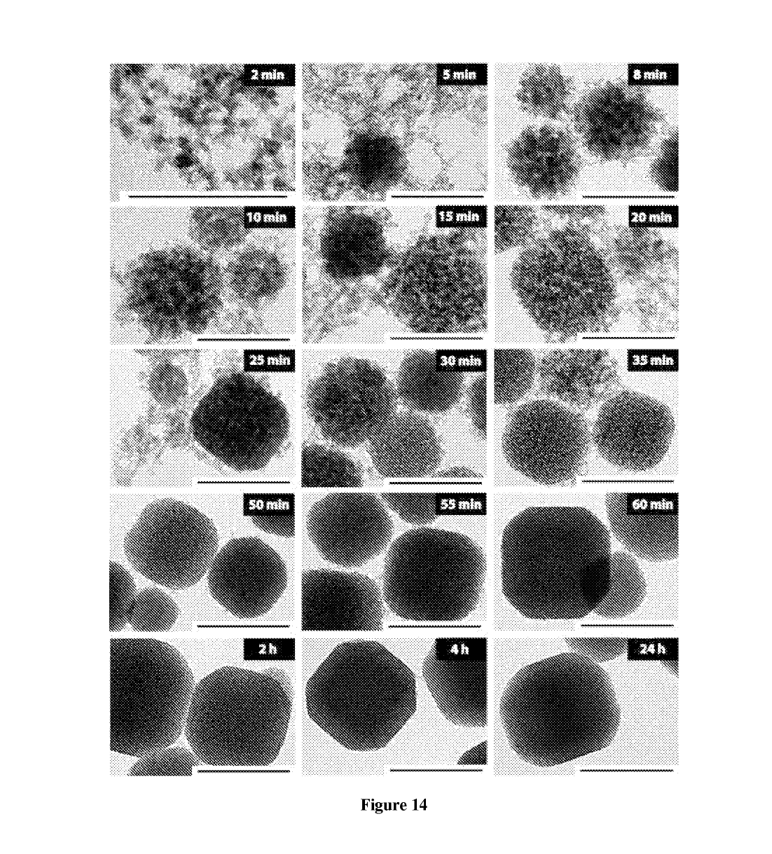

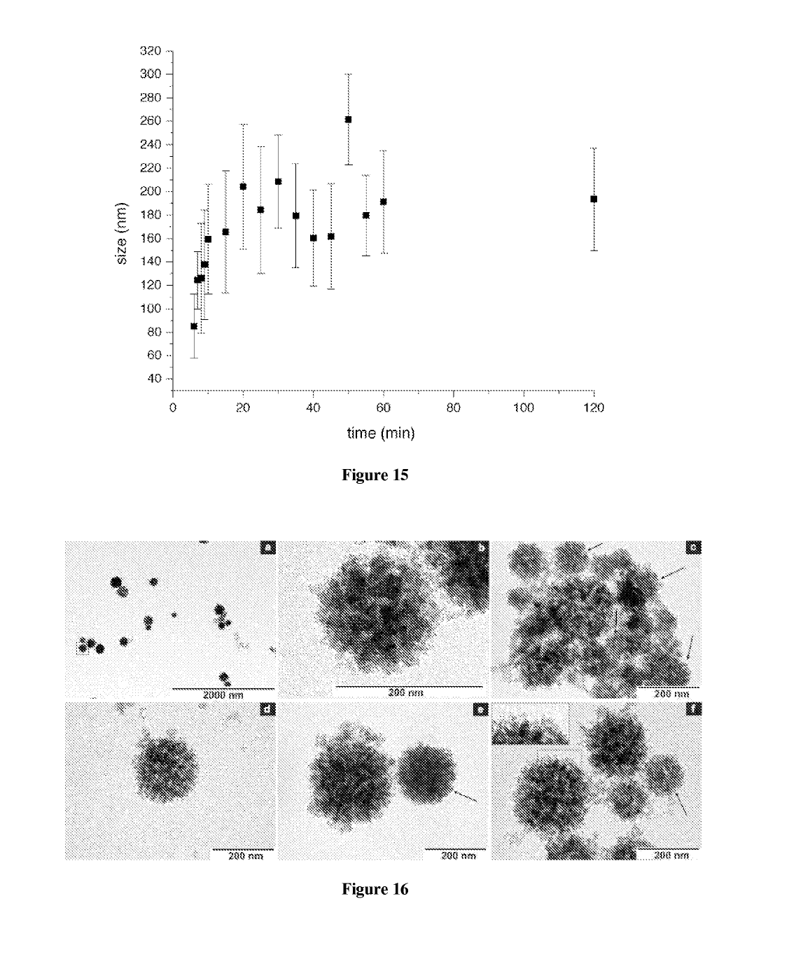

TEM and SAXS Study of Cubic Particle Formation Mechanism. Among all samples containing different amounts of APTES, the 54-NH₂-MSNs are particularly interesting as they exhibit a structure consistent with cubic Pm 3̅n symmetry and a fairly regular, truncated octahedral shape. The following discussion will thus entirely focus on these materials. The formation mechanism of cubic-type morphologies is more complicated than that of MCM-41 type structures. Acid-catalyzed syntheses of Pm 3̅n mesoporous silica from cationic surfactants, referred to as SBA-1, have been more intensively explored than the corresponding base-catalyzed systems, referred to as SBA-6. In order to better understand the formation mechanism of the highly aminated cubic Pm 3̅n mesoporous silica nanoparticles prepared in this approach, we looked at the particle structure at different time points in the synthesis. To this end, after chemical reagents were mixed for 5 minutes and water was added into the reaction, aliquots were taken out at different time points after water addition, similar to what we reported in an earlier study on room temperature hexagonal MSN synthesis. Each aliquot was neutralized to halt ongoing chemical processes. The surfactant template was then removed by acid extraction, and samples were subsequently dried in vacuum. TEM images of 54-NH₂-MSNs at different reaction times prepared in this way are shown in FIG. 14. Clusters of small silica nanoparticles are first formed (2 minutes), and as a function of reaction time, these particles aggregate and grow. From TEM analysis, between 5 and 20 minutes the average particle size increases the most and then becomes relatively constant after 20 minutes, see FIG. 15.

In addition to the size evolution, a structural transition to more and more ordered mesostructures with well-defined particle shape is observed with time. At very early stages (2 minutes), relatively unstructured silica aggregates/clusters of varying sizes below ˜20 nm are found. At 5 minutes, a few larger, about 100 nm-sized, particles can already be discerned among a large number of small silica clusters (5-10 nm). Between 8 and 20 minutes, more and more of such larger particles occur that are very heterogeneous in nature as indicated by significant density variations observed in TEM across individual particles. FIG. 16 shows TEM images taken at 8 (a-b), 9 (c-d), and 10 (e-f) minute time points. Some degree of structural periodicity within the particles can clearly be discerned for particles in FIG. 16. For example the particle in FIG. 16b clearly exhibits lattice fringes across the entire object (note that these fringes are only observed in TEM for specific particle orientations). Arrows in FIG. 16 indicate other particles where such fringes are visible upon magnification. This observation is particularly surprising in light of the fact that the overall particle structure is rather heterogeneous with significant density variations across the particle and a rather ill-defined particle surface topology. The surface of these growing, loosely packed particles is decorated with small and structured (anisotropic) silica clusters, e.g. see inset in FIG. 16f. This observation implies that clusters reflecting the spherelike geometry of surfactant micelles but anisotropic in the silica distribution are added onto the growing particles. Cube-shaped particles reflecting the intrinsic cubic mesostructure are clearly observed at around 15-20 minutes (FIG. 14). The number of octahedrally shaped MSNs increases as the reaction time proceeds, and their density becomes more and more homogeneous. At the same time the amount of primary silica clusters goes down (compare images in FIG. 14 after 5 and 55 minutes). No significant structural changes are observed beyond 1-2 hours of aging time, at which point the particle structure is fully developed.

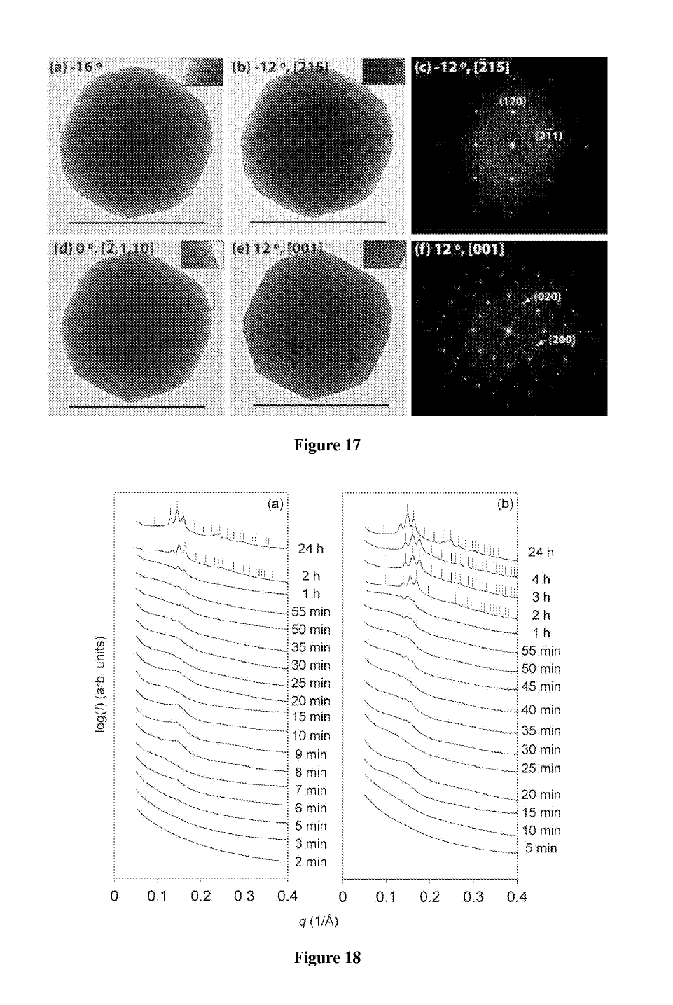

In order to further corroborate the cubic pore structure, FIG. 17 shows a series of TEM images taken at different rotation angles of a specific particle of a 54-NH₂-MSN batch that has gone through the full (i.e., 24 hours) reaction time. Tilting the octahedrally shaped single-domain particle by different angles reveals several projections corresponding to a cubic Pm 3̅n structure including zone axes of [001], [ 2̅, 1, 10], and [ 2̅, 1,5] (see FIG. 17(b, d, e), respectively). In particular the [001] projection is very characteristic for this morphology. Fast Fourier transform (FFT) patterns of the TEM images show spots consistent with the structural assignment: for example, the projection along [001] zone axis shows that spots corresponding to (h00), where h is odd, have zero intensities, consistent with the systemic absence condition for the Pm 3̅n structure (FIG. 17f).

SAXS scattering patterns of two independent sets (a,b) of 54-NH₂-MSNs taken at different synthesis time points are shown in FIG. 18. In FIG. 18a, SAXS traces are depicted for the same sample series for which the TEM results are shown in FIGS. 14 and 16. Samples taken at 2-3 minutes show no structural scattering peak. Samples taken at 5-30 minutes show either a broad hump or a weak peak around q=0.14 Å⁻¹. This peak appears as early as the 6 and 8 minute time point, consistent with the first appearance of lattice fringes in TEM, see FIG. 16b. At 35 minutes, small peaks angles appear at q=0.144 and 0.16 A⁻¹ The intensity of these two peaks becomes more pronounced as time progresses. After a reaction time of 60 minutes, a third peak at q=0.13 Å⁻¹ can be identified. These three peaks can be assigned as {200}, {210}, and {211} reflections of a cubic lattice. After 2 hours additional higher ordered peaks occur also consistent with a Pm 3̅n lattice. In order to clarify the significance of the heterogeneities in the SAXS results, in particular between 10 and 30 minutes (see appearance and disappearance of reflections during this time window in FIG. 18a) experiments were repeated on a separately synthesized batch. SAXS diffractograms of this second sample series show similar trends as the first one, except that the appearance of first scattering peaks is delayed relative to the first series (FIG. 18b).

For comparison, we also studied in more detail the formation of aminated MSNs prepared at much lower amount of APTES in the feed, i.e. 19-NH₂-MSNs. This sample possesses hexagonal pore arrangement as inferred from data depicted in FIGS. 10d and 11 (trace c). FIGS. 24 and 25 show TEM images and SAXS diffractograms of 19-NH₂-MSNs taken at different synthesis time points after removal of CTAB, respectively. As previously described for nonaminated CTAB-templated as well as Pluronics Pl23-templated MSNs, hexagonal pore packing already forms at an early stage (see scattering peaks consistent with a hexagonal lattice at the 3 minute time point in FIG. 25). As time progresses, the characteristic peaks of a hexagonal morphology become pronounced. In contrast to the cubic nanoparticles, no significant structural changes are observed beyond 5 minutes (FIG. 25). These results confirm the strong influence of the organically modified silane, APTES, in the reaction feed on the formation mechanism and final structure of mesoporous silica nanoparticles.

Discussion of Formation Mechanism. Besides cationic surfactants, anionic surfactants can be used as templates to synthesize a variety of cubic mesocages of silica materials at elevated temperatures in the presence of alkoxysilane as costructure-directing agents (CSDA), for example, APTES. This family has been known as anionic-templated mesoporous silica or AMS-n. The formation mechanism of AMS-n materials has been discussed in terms of a crystal growth mechanism via the self-assembly and layered growth of spherical or pseudospherical micelles of different sizes. Spherical micelles are formed via electrostatic interactions between head groups of anionic surfactants and amine moieties of the CSDA, which are partially hydrolyzed and condensed to form a thin silica shell. TEM images of the calcined product revealed mesoporous particles possessing cubic symmetry with rugged surfaces. Based upon the observed surface structure, stacking faults, and preferential growth perpendicular to the {111} surface, it was proposed that growth of these particles proceeds via layer-by-layer growth (a classical crystal growth mechanism), in which the building blocks are spherical silica particles.

The experimental findings reported here are in stark contrast with layer-by-layer growth or any other classical crystal growth mechanism. The observations of the time-evolution of particle size and shape in a room-temperature synthesis of 54-NH₂-MSNs clearly deviate from classical particle growth as reported in previous studies. In particular the TEM images of samples taken at time points from 8 to 20 minutes (FIGS. 14 and 16) illustrate two characteristics that are not consistent with a classical growth mechanism: First, particles are initially loosely packed and have significant heterogeneities in their density throughout the particle which only disappears over time. Second, particle growth occurs via addition of preformed and structured silica clusters that are clearly evident in the TEM images. Most interestingly, the heterogeneous, loosely packed particles formed at early time points, display both lattice fringes and facets, which suggest some degree of long-range order across the entire particle (FIG. 16). These observations suggest a nonclassical crystal growth mechanism, such as the recently described theories of “mesocrystal” formation and “oriented aggregation,” which have been developed to explain the formation of some types of single crystals from nanoparticle building blocks. A mesocrystal, for example, is defined as a particle composed of primary units (such as crystalline inorganic nanoparticles or organic molecules) in crystallo-graphic registry but without full structural coherence. In this state, the primary nanocrystals exhibit crystallographic alignment despite spatial separation from one another, which bares similarities with features observed in the case at early particle formation stages (8-20 minutes). As time progresses, packing of the mesoporous particles becomes more and more dense and uniform, and well-defined and octahedrally shaped MSNs are then formed. To the best of our knowledge, this is the first report revealing such a nonclassical formation mechanism for a mesoscopically ordered, locally amorphous material (silica), i.e. highly aminated MSNs with Pm 3̅n symmetry. Slowing down the reaction rate by using room temperature as well as high amounts of APTES in the reaction feed were critical steps enabling capture of this unusual particle growth mechanism.

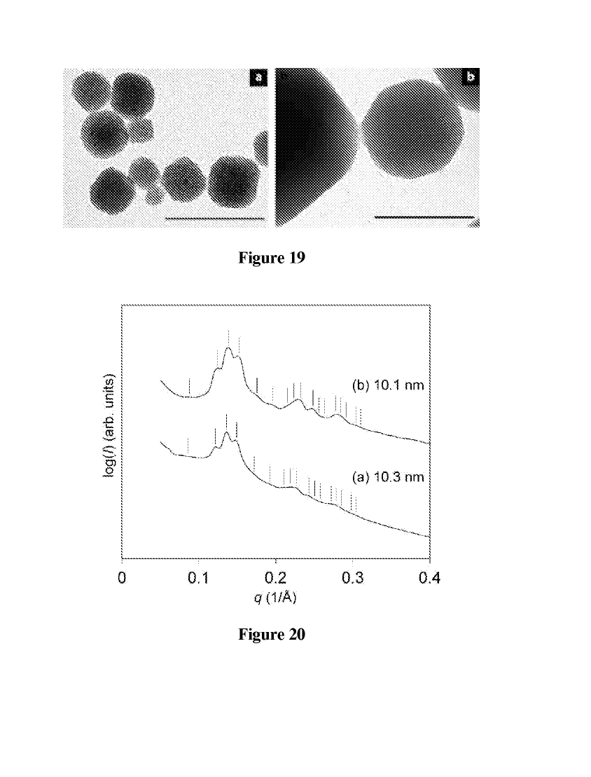

Particle Syntheses As a Function of Catalyst Concentration. As mentioned before, a current challenge in the synthesis of organically modified ordered MSNs via co-condensation routes is the limited amount of organosilane, here APTES, being incorporated. Primary amine groups of APTES can be either in protonated or in deprotonated (neutral) form, depending on the pH of the synthesis environment. The majority of amine groups in the synthesis conditions used here is expected to be in neutral form as the solution pH=11 is above the pKₐ=10.6 of APTES. The aminopropyl moieties of the APTES molecules can then intercalate into the hydrophobic micelle cores, which consequently alters the curvature of the micelles from low (10-49 mol % APTES) to high surface curvature (54-64 mol % APTES), favoring the formation of a cubic morphology. In order to support this suggested mechanism, we varied the pH of the synthesis solutions by changing the concentration of NH₄OH from the original condition (207.5 mM). The pH levels of solutions containing (a) 103.75 and (b) 409 mM NH₄OH were at 10 and 11, respectively. Though there was no significant change in solution pH, from the proximity to the pKₐ=10.6 of APTES we expected the equilibrium of amino groups between protonated and deprotonated states to be affected. Corresponding TEM images of the resulting 54-NH₂-MSNs using the two different amounts of NH₄OH are shown in FIG. 19. While images of both geometry samples show typical projections of the cubic Pm 3̅n structure, e.g. [100] (compare with FIG. 17), size and shape of the resulting particles are different from the result of the original synthesis. At a lower pH of 10, a larger number of amino groups of APTES are expected to be protonated. The probability that APTES molecules intercalate into micelles should then be lower as a result of the electrostatic repulsion with the cationic head groups of the surfactants. Surprisingly, NH₂-MSNs with cubic shape and structure were also obtained under these conditions, though the resulting particle shape is slightly irregular. These observations suggest that the effects may be subtler than a simple APTES induced change in micelle geometry. They also reveal that the synthesis protocol described here for MSNs with cubic Pm 3̅n structure is rather robust.

Aminated materials synthesized at lower catalyst content or lower pH (103.7 mM NH₄OH) have considerably smaller particle size, while the isotropic nature of particle shape and inner structures observed in TEM images both suggest a cubic symmetry for these particles. From the higher pH synthesis (409 mM NH₄OH), particles are larger in size and exhibit a higher number of well-defined facets. These results suggest that differences in nucleation, hydrolysis, and condensation rates of silica in these two systems determine the final size and details of the shape of NH₂-MSNs. The results are similar to what has been reported in acid-catalyzed systems using a single silane precursor. In the preparation of SBA-1, for example, the acidity of the solution with respect to the isoelectric point of silica affects hydrolysis and condensation rates of silica, which consequently changes the shape of the resulting particles without disturbing mesostructure. Effects of pH in the synthesis of cubic Pm 3̅n structures in basic solution have not yet been carefully examined. From this work, at higher pH, where the condensation rate of silica is slow, particle growth should be more thermodynamically controlled, which then yields well-defined NH₂-MSNs with truncated-octahedral shape. On the other hand, at less basicity, growth of particles is expected to be more kinetically controlled as the condensation rate of silica is faster. Consequently, less well-defined NH₂-MSNs exhibiting fewer facets were formed.

SAXS scattering patterns of 54-NH₂-MSNs prepared under different NH₄OH concentrations are shown in FIG. 20(a-b). Regardless of catalyst concentration and irrespective of final particle size and shape, SAXS diffractograms of both samples exhibit similar patterns to those of 54-NH₂-MSNs synthesized at the original catalyst amount (207.5 mM, FIG. 11) and can be indexed consistent with a cubic lattice with Pm 3̅n symmetry.

In this example we reported the synthesis of NH₂-MSNs from different amounts of APTES in the reaction feed. By increasing APTES concentrations, mesoporous particle structure altered from hexagonal to cubic Pm 3̅n to disordered. Investigation of the structure evolution of Pm 3̅n cubic 54-NH₂-MSNs, as a function of time, revealed a gradual transition from silica clusters approximately 5 to 20 nm in size (˜2 minutes) to loosely packed particles with heterogeneous density but long-range order across the particle (8-30 minutes) to fully developed particles with cubic lattices (>1 hour). TEM imaging revealed that the particles grow through addition of preformed and prestructured silica clusters. Size and shape of highly aminated Pm 3̅n MSNs using 54 mol % APTES could be further controlled by means of tuning pH using different NH₄OH concentrations. At the highest catalyst amount and pH, through slower silica condensation rates, growth of particles is less kinetically controlled, resulting in the formation of aminated Pm 3̅n MSNs with larger size and higher number of well-defined crystal facets as compared to particles prepared at lower pH. Features of the structural particle evolution as revealed by TEM bear striking similarities to recently discussed nonclassical single crystal growth mechanisms such as mesocrystal formation or oriented aggregation. The comparisons pose fundamental questions about the relation between formation mechanisms of classical crystalline materials and mesoscopically ordered, locally amorphous materials as studied here. As the material constituting the mesoporous particles is silica, which is amorphous, we speculate that it is the co-continuous nature of the inorganic as well as the organic networks with Pm 3̅n symmetry that provide information about the orientation of subsequent silica cluster attachments from solution. This implies that these silica clusters are anisotropic in shape with surface patches exposing organic/surfactant material and patches exposing inorganic/silica material resulting in an oriented, as opposed to a random, attachment to the growing mesoporous silica particle.

### EXAMPLE 4

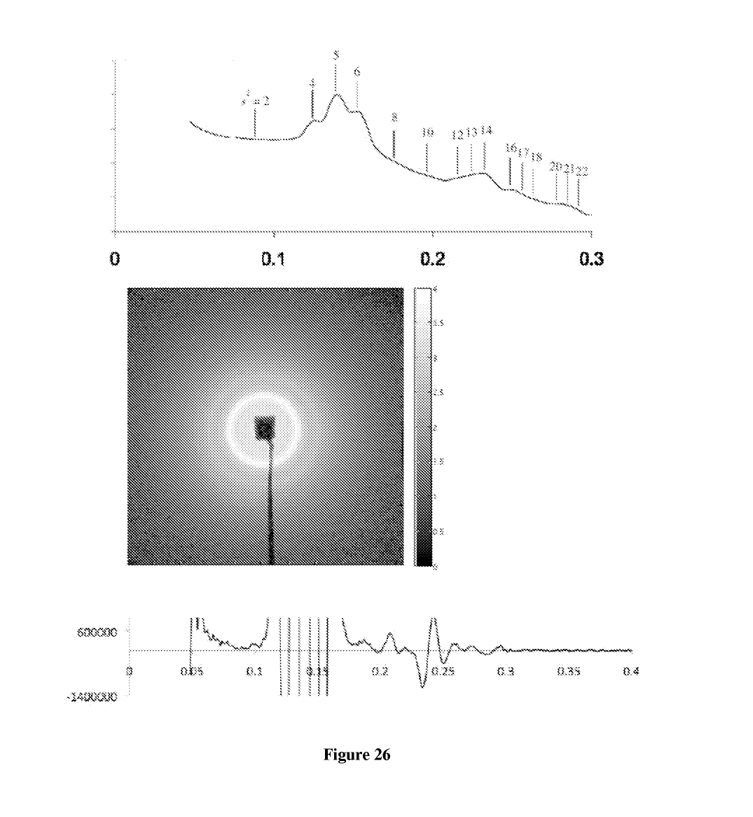

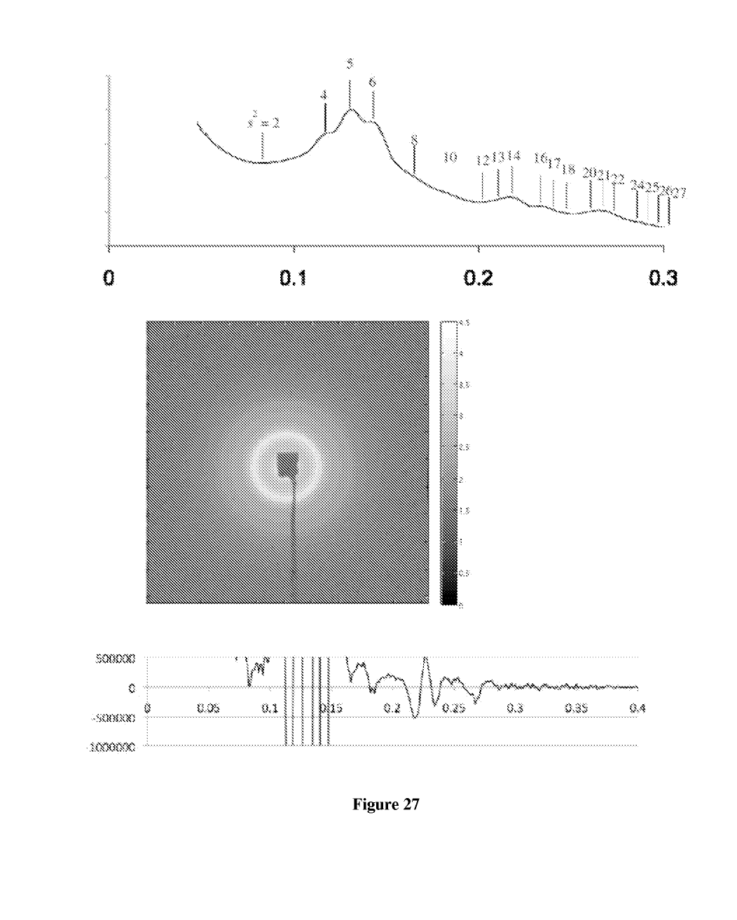

This example shows the SAXS structural analysis on cage-like cubic mesoporous silica nanoparticles (FIGS. 26-35).

Here we detail the information regarding the structural assignment on the small angle x-ray scattering (SAXS) patterns of cubic cage-like mesoporous silica nanoparticles (MSNs). Details for indexing the X-ray patterns for these particles are given. For cubic symmetry with aspect 5 (P43n and Pm 3̅n), the allowed reflections index with s²=h²+h²+l²=2, 4, 5, 6, 8, 10, 12, 13, 14, 16, 17, 18, 20, 21, 22, . . . (systemic absence of hkl with h=k and l=odd). The most notable feature for this set of reflections is the s²=4, 5 and 6 peaks. Out of the 17 cubic symmetry aspects, aspects 1, 2, 5 and 7 have these peaks allowed, and the possibility of assigning s²=8, 10 and 12 to these peaks are excluded because this puts the next strong peak at s²=28, which cannot be the sum of three squares. This thus excludes all other possibilities than aspects 1, 2, 5 and 7.

The next step is to distinguish aspects 5 and 7. The key factors between the remaining aspects 5 and 7 is the existence of s²=2 and 10 for aspect 5, and the existence of s²=3, 9 and 11 for aspect 7. We were able to see the reflections for s²=2 and 10 in the second order finite difference patterns and thus concluded that these MSNs have aspect 5 symmetry (we have simply rejected aspects 1 and 2 due to the absence of a major number of peaks in the low index regions). In order to say that the patterns in FIGS. 26-35 show symmetries inconsistent with Aspect 7, we need to show the presence of either reflection at s²=2 or 10.

Aspects 1 and 2 are always impossible to rule out by this method, but we can say that the number of missing peaks are simply too large to reasonably assign these lower symmetries. We also note that this ensemble measurement cannot exclude structural heterogeneity, i.e. the peaks consist of multiple symmetries. In FIGS. 26-35, the top plots show the one-dimensional (1D) scattering patterns azimuthally integrated from the raw two-dimensional (2D) patterns around the beam center. The units are log (Intensity) in arbitrary units vs. q=4π sin θ/λ in Å⁻¹ where 2θ is the total scattering angle and λ is the x-ray wavelength. Tick marks represent where the expected peak positions for Pm 3̅n structures would be. The middle figure in FIGS. 26-35 is the 2D x-ray image. An optional bottom figure in FIGS. 26-35 shows the second finite difference plot of the I vs. q plot. Local minima in this plot correspond to the peak positions in the I vs. q plot.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A mesoporous silica particle comprising 10 mole % to 65 mole % amine groups present in the silica of the particle and on the silica surface of the particle, the particle mesostructure having cubic Pm 3̅n symmetry and the particle having a size of 25 nm to 500 nm.

2) The particle of claim 1, wherein the shape of the particle is truncated octahedral or cube-like.

3) The particle of claim 1, further comprising a plurality of cationic surfactant molecules.

4) The particle of claim 1, further comprising a plurality of organic materials.

5) The particle of claim 4, wherein the organic materials are selected from organic compounds, biomaterials, and combinations thereof.

6) The particle of claim 5, wherein the organic compounds are selected from drugs, imaging probes, metal chelators, contrast agents, sensor molecules, inhibitors, targeting moieties, polymers, and combinations thereof.

7) The particle of claim 5, wherein the biomaterials are selected from siRNA, DNA, RNA, enzymes, cell targeting components, proteins, liposomes, and combinations thereof.

8) The particle of claim 1, wherein at least a portion of a first surface of the particle is functionalized with a first functional group and/or a first functional moiety.

9) The particle of claim 8, wherein the first surface of the particle is an exterior surface, an interior surface, or both an exterior surface and an interior surface.

10) The particle of claim 8, wherein at least a portion of a second surface of the particle is functionalized with a second functional group and/or second functional moiety.

11) The particle of claim 8, wherein the particle surface is functionalized with polymer groups, targeting moieties, antibodies, peptides, nucleic acids, imaging probes, proteins, liposomes, polymers, and combinations thereof.

12) A method for making a mesoporous silica particle comprising 10 mole % to 65 mole % amine groups present in the silica of the particle and on the silica surface of the particle, the particle mesostructure having cubic Pm 3̅n symmetry, and the particle having a size of 25 nm to 500 nm comprising the steps of:
a) forming a reaction mixture comprising one or more silane precursor, one or more amino silane precursor, optionally, one or more pore expander molecule, one or more cationic surfactant, and an aqueous solvent,
wherein the mole % of amino silane precursor is from 10 mole % to 65 mole %,
the pH of the reaction mixture is 10 to 11, and
the reaction mixture is formed at a temperature of 15° C. to 25° C.;
b) allowing the reaction to proceed at a temperature of 15° C. to 25° C. until the desired mesoporous silica particles are formed

13) The method of claim 12, further comprising the steps of neutralizing the reaction mixture and isolating the particles.

14) The method of claim 13, further comprising the step of removing the cationic surfactant.

15) The method of claim 12, where the silane precursor is tetraethyl orthosilicate, tetrapropyl orthosilicate, or a combination thereof.

16) The method of claim 12, wherein the amine silane precursor is APTES, APTMS, N-(2-amino ethyl)-3-aminopropyltrimethoxysilane, or a combination thereof.

17) An imaging method using mesoporous silica particles of claim 1 comprising the steps of:
a) contacting a cell with the mesoporous silica particles of claim 1 such that the cell takes up at least a portion of the particles; and
b) obtaining an image of the cell from a).

18) The method of claim 17, wherein the image is obtained using confocal microscopy, fluorescence microscopy, two-photon excitation microscopy, positron emission tomography, magnetic resonance imaging, computer tomography, and combinations thereof.
